(19) United States
(12) Patent Application Publication
(10) Pub. No.: US 2022/0396704 A1
(43) Pub. Date: Dec. 15, 2022

(54) Antimicrobial Coatings

(71) Applicant: Agienic Inc., Tucson, AZ (US)

(72) Inventors: Jeganathan Akilavasan, Tucson, AZ (US); Kyler Novotony, Tucson, AZ (US); Anoop Agrawal, Tucson, AZ (US); Donald R. Uhlmann, Tucson, AZ (US)

(73) Assignee: Agienic Inc., Tucson, AZ (US)

(21) Appl. No.: 17/855,951

(22) Filed: Jul. 1, 2022

Related U.S. Application Data
(63) Continuation-in-part of application No. 17/571,143, filed on Jan. 7, 2022.
(60) Provisional application No. 63/143,385, filed on Jan. 29, 2021.
(60) Provisional application No. 63/134,998, filed on Jan. 8, 2021.

(51) Int. Cl. C09D 1/00; A41D 13/12; A41D 13/11; D06M 11/13; C09D 5/14

(52) U.S. Cl. CPC C09D 1/00; A41D 13/1209; A41D 13/1192; D06M 11/13; C09D 5/14; D06M 2101/20

(57) ABSTRACT

Aqueous formulations containing antimicrobial materials dispersed in solutions or emulsions, methods of their preparation, application of such compositions to surfaces, and their resulting coatings. Coating of hydrophobic surfaces with aqueous solutions or suspensions containing antimicrobial materials are disclosed. Several applications of the antimicrobial coatings are described including the coating of solid and porous substrates such as fabrics which may be used for gowns, masks, and other personal protection equipment.

### CROSS-REFERENCE TO RELATED APPLICATIONS

This application is a continuation-in-part of U.S. Ser. No. 17/571,143, filed Jan. 7, 2022, which claims priority benefit of U.S. provisional application 63/134,998, filed Jan. 8, 2021, and U.S. provisional application 63/143,385, filed Jan. 29, 2021, which are incorporated herein by reference in their entireties.

### STATEMENT REGARDING FEDERALLY SPONSORED RESEARCH

This invention was made with Government support under Agreement 75A50120000008 awarded by HHS. The Government has certain rights in the invention.

### FIELD OF THE INVENTION

This invention relates to aqueous formulations comprised of antimicrobial materials dispersed in solutions or emulsions, the methods of their preparation, application of such compositions to surfaces, and their resulting coatings. Several applications of the antimicrobial coatings are described herein, including the coating of solid and porous substrates such as fabrics which may be used for gowns, masks, and other personal protection equipment.

### BACKGROUND

Humans are exposed to a variety of air-borne contaminants and pathogens including harmful microbes such as viruses, bacteria, mycobacteria, yeast, fungi, etc. Exposure to the contaminants and these microbes may be via air, direct contact, indirect contact, etc. There is a long-felt and unmet need for compositions, materials, and methods for preventing such exposures.

### SUMMARY OF THE INVENTION

In one aspect, the present disclosure includes a combination including a coating formulation and a substrate for providing antimicrobial properties to the substrate to which the coating formulation is applied, wherein the coating formulation comprises an aqueous suspension of at least one low water solubility copper salt and the substrate is hydrophobic.

In one aspect, the present disclosure includes a product selected from at least one of a face mask, a hair covering or a gown wherein the fabrics used for fabricating these products are coated with an antimicrobial formulation including particles of a low water solubility copper compound, and these fabrics may comprise polypropylene fibers.

In one aspect, the present disclosure includes a mask or gown including a fabric of a hydrophobic polymer coated with an aqueous formulation of cuprous iodide particles which, when put in contact with MS2 coliphage, kills at least 99.9% of said MS2 coliphage in a period of 15 minutes or less.

In another aspect, the present disclosure includes a mask or gown including a fabric of a hydrophobic polymer coated with an aqueous formulation of cuprous iodide particles which, when put in contact with MS2 coliphage, kills at least 99.9% of said MS2 coliphage in a period of 15 minutes or less, and this kill rate is maintained if then same area of the mask, gown or a coated fabric is examined repeatedly for at least three times.

In one aspect, the present disclosure includes a mask or a gown including a non-woven hydrophobic polymer fabric with a coating including functionalized particles of cuprous iodide deposited from an aqueous suspension containing at least one surfactant.

In one aspect, the present disclosure includes a mask or a gown including a non-woven hydrophobic polymer fabric with a coating including functionalized particles of cuprous iodide deposited from an aqueous suspension containing at least one polymer which is not water soluble.

In another aspect, the present disclosure includes an air filter or a fabric for use in an air filter, wherein a hydrophobic polymer coated with an aqueous formulation containing low-water solubility copper compound; these air filters have applications in for filtering air for building interiors and for transportation cabin filters (for example in planes, cars, trains, boats, trucks and buses).

To prevent exposure and infection with pathogens and harmful microbes, antimicrobial materials may be applied to a variety of products, incorporated in the form of a polymeric coating. A non-exhaustive list of such products that may be coated is provided below. The antimicrobial coatings may be applied to the products themselves, or to their individual material components (e.g., fibers, fabrics).

TABLE 1
Representative Applications of Antimicrobial Coatings

| No. | Application |
|---|---|
| 1. | Body implants |
| 2. | Sutures and medical devices |
| 3. | Pacemaker housings and leads |
| 4. | Filters for water supplies and air, including applications for building and |
| | transportation |
| 5. | Personal protection wear, including clothing, face masks, gloves, gowns, |
| | shoes, hair coverings (including caps) and respirators for the public, medical |
| | personnel and/or other industrial workers |
| 6. | Diapers |
| 7. | Ventilators, air ducts, cooling coils and radiators for use in buildings and |
| | transportation |
| 8. | Medical and surgical gloves |
| 9. | Textiles including bedding and furniture coverings, towels, undergarments and |
| | socks |
| 10. | Upholstery, carpets and other fibrous textiles |
| 11. | Furniture for public use, as in hospitals, doctors' offices and restaurants |
| 12. | Paints for use in buildings, including public buildings such as hospitals, |
| | doctors' offices, schools, restaurants and hotels |
| 13. | Transportation (ships, planes, buses, trains and automobiles) and building |
| | surfaces such as walls, floors, toilet seats, knobs, handles, switches, tables, |
| | steering wheels, and seats |
| 14. | Coatings on shopping bags |
| 15. | Coatings on school furniture |
| 16. | Coatings on plastic containers and trays (for example those used at the airports |
| | to screen passenger belongings) |
| 17. | Purses, wallets and shoes |
| 18. | Gloves, and liners for gloves, shoes and jackets |
| 19. | Shower heads |
| 20. | Self-disinfecting cloths, disposable tissue papers |
| 21. | Bottles containing medical or ophthalmic solutions |
| 22. | Keyboards, switches, knobs, handles, remote controls, and displays of cell |
| | phones, appliances, and other portable electronics |
| 23. | Toys, books and other articles for children |
| 24. | Gambling chips, gaming machines, dice, etc. |
| 25. | Handles of shopping carts |
| 26. | Cribs and bassinettes |
| 27. | Bottle coatings for infant's bottles |
| 28. | On personal items/use such as toothbrushes, hair curlers/straighteners, combs |
| | and hair brushes, nail polish |
| 29. | Currency, including paper, tissue paper, plastic and metal |
| 30. | Sporting goods such as tennis rackets, gold clubs, gold balls and fishing rods |
| 31. | Medical and marine applications to prevent biofilms |
| 32. | Dental applications- implants, composite fillings, crowns, denture materials. |
| 33. | Molded and extruded products, including waste containers, devices, tubing, |
| | films, bags, liners gaskets and foam products. |
| 34. | Flowers and flower heads |
| 35. | Portable toilets |

In one embodiment, the antimicrobial materials are particles of low-water solubility metal compounds which are pre-formed and incorporated in coatings to provide antimicrobial activity. Pre-formed means that these particles are formed prior to their incorporation into the coatings (or coating formulations). In another embodiment, the particles may not be pre-formed i.e., they are formed in-situ as the coating is being formed (e.g., by precipitation, or reduction and oxidation of a certain compound in the coating formulation). In one possible form of aqueous suspensions, the particles are typically stabilized through introducing a functionalizing agent on their surfaces. This provides the particles with improved stability against aggregation as well as surface functional groups which allow for additional benefits as discussed later. A variety of these low water-solubility metal compounds have been investigated, including metal oxides and metal halides. Antimicrobial activity is generally achieved by the release of metal ions from these particles, which kill microbes by penetrating them or damaging their membranes. Metals of interest include copper, silver, and zinc, all of which have shown high efficacy against microbes and low toxicity to the humans. A specific material which is used to demonstrate the various aspects of this disclosure is copper (I) iodide or cuprous iodide. When the compositions used herein contain low water solubility particles with antimicrobial properties they may be optionally combined with other known antimicrobial materials. For example, some other antimicrobial materials which may be optionally incorporated in these formulations are organic and inorganic materials including quaternary ammonium compounds, N-halamine polymers, antimicrobial metals, other metal compounds, antibiotics, etc.

One aspect of the disclosure is the use of select antimicrobial particles in aqueous formulations to produce coatings on various surfaces. Benefits of using aqueous-based systems include lower costs, fewer restrictions on handling, and a much safer production line. One specific aspect of this invention is to coat hydrophobic surfaces or those that contain hydrophobic materials as they are difficult to coat using aqueous formulations as by definition, water will not wet hydrophobic surfaces. Some of the substrates which may be coated include solid surfaces (flat sheets, tubes, other shapes) and fabrics for use in masks, gowns, filters, gloves, and other personal protective equipment. Additionally, these articles may be disposable, non-disposable, or worn for extended periods of time, such as for an entire shift of 4 to 24 hours or longer. Many such fabrics include fibers made from hydrophobic materials such as polypropylene, silk or polyester, which are difficult to coat with aqueous formulations due to their hydrophobicity and low surface energy. The coatings and formulations put forward herein describe the use of antimicrobial particles and specific additives to the formulations, so that an aqueous formulation is able to wet and coat the hydrophobic surfaces in a uniform fashion, and after drying/solidification the coating is well adhered to these surfaces and retains the antimicrobial particles. These additives include polymers, surfactants, adhesion promoters, binders, compatibilizing agents, colorants, drying agents, viscosity modifying agents and other such additives, to overcome challenges associated with coating hydrophobic materials with aqueous formulations.

In addition to their outstanding antimicrobial properties, many of the products of the present invention also have usefulness for reducing inhaled airborne pollutants, e.g., in face masks.

Other features and characteristics of the subject matter of this disclosure, as well as the methods of operation, functions of related elements of structure and the combination of parts, and economies of manufacture, will become more apparent upon consideration of the following description and the appended claims, all of which form a part of this specification.

### BRIEF DESCRIPTION OF THE DRAWINGS

FIG. 1 shows a schematic of a face mask according to the present disclosure;

FIG. 2 shows a schematic of a building air filter or a cabin air filter used in transportation according to the present disclosure.

### DETAILED DESCRIPTION

While aspects of the subject matter of the present disclosure may be embodied in a variety of forms, the following description is merely intended to disclose some of these forms as specific examples of the subject matter encompassed by the present disclosure. Accordingly, the subject matter of this disclosure is not intended to be limited to the forms or embodiments so described. In understanding the scope of the present disclosure, the terms “including” or “comprising” and their derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of,” as used herein, is intended to specify the presence of the stated features, elements, components, groups, integers, and/or steps as well as those that do not materially affect the basic and novel characteristic(s) of features, elements, components, groups, integers, and/or steps. It is understood that reference to any one of these transition terms (i.e. “comprising,” “consisting,” or “consisting essentially”) provides direct support for replacement to any of the other transition term not specifically used. For example, amending a term from “comprising” to “consisting essentially of” would find direct support due to this definition.

The term “amphiphilic polymers” is directed to the class of water-soluble polymers which have both hydrophilic and hydrophobic moieties, making them capable of solvating two disparate phases. Some examples of amphiphilic polymers include but are not limited to block copolymers, including those block copolymers where at least one block is selected from the hydrophilic polymer list, and at least one block may be selected from the hydrophobic polymer list. Some examples are PVP-block-polypropyleneoxide-block; polyethyleneoxide-block-polypropyleneoxide-block-polyethyleneoxide-block; polyethyleneoxide-block-polypropylene oxide-block.

The term “aqueous formulation” means that the water content of the aqueous formulation or the coating composition is greater than about 30% by weight. In another embodiment, this is greater than about 50% and in yet another embodiment this is greater than about 80%. In these formulations, the weight percentage of water is less than about 99% in one embodiment and in another embodiment less than about 95%. In another embodiment the only solvent used in the aqueous formulation is water. The aqueous formulations may also contain other co-solvents which are soluble in water and used to modify properties such as processability, surface tension, viscosity, drying rate, and/or ability to solubilize other materials. Some examples include ethanol, acetone, methyl ethyl ketone and non-ionic surfactants which have a boiling point of less than 220° C.

The term “average particle size” is the average particle size as measured by laser light scattering, unless mentioned otherwise. For particulate suspensions, laser light scattering method is preferred among the various methods discussed below, and this measurement shall prevail if different methods are used to establish the particle sizes and there are differences among them. Some other methods include dynamic light scattering, scanning electron microscopy, and transmission electron microscopy. For a sampling of particles which are non-spherical in shape, the average particle size is to be taken as the equivalent spherical diameter for particles having the same volume as the non-spherical particles.

The “average particle size” or “particle size” in a suspension used to make coating formulations may be characterized as micro or nano depending on their sizes. The term “nano” may be used to describe suspensions of particles of antimicrobial metal compounds wherein the average particle size is smaller than 100 nm. A preferred range of nanoparticles will have an average size in the range of 4 to 100 nm. The term “micro” may be used to describe suspensions of particles of antimicrobial metal compounds wherein the average size is in the range of about 100 nm to 1,500 nm. All percentages referenced herein refer to percentage by weight of the particles. In additional embodiments, the percentage of particles with a size greater than 1.5 μm must be less than 10%, and in another embodiment, this is to be less than 20%. In another embodiment the range of sizes is about 200 nm to 1000 nm. In this particle size range, in an additional embodiment, the percentage of particles with a size greater than 1 μm must be less than 10%, and in another embodiment, this is to be less than 20%. In a further embodiment, the percentage of particles with a size less than 100 nm must be less than 10%, and in another embodiment less than 5%. As an example of “micro”, the average size of the particles is in the range of 200 nm to 1000 nm and the distribution of particle sizes has less than 10% smaller than 100 nm and less than 10% greater than 1 um

The term “anti-bacterial effect” means the killing or reduction in the numbers of bacteria.

The term “anti-fungal effect” means the killing or reduction in the numbers of mold and/or fungi.

The term “anti-spore effect” means the killing or reduction in the numbers of spores.

The term “anti-viral effect” means the killing or reduction in the numbers of viruses.

The term “antimicrobial effect” is broadly construed to mean killing or reduction in the numbers of any of the microorganisms in the classes of bacteria (including mycobacteria), viruses, mold, fungi, or spores. “Antimicrobial effect” includes killing of any individual or group of bacteria, viruses, mold, fungi, or spores

The term, “antimicrobially effective amount” of any agent mentioned herein as having an antimicrobial effect is a concentration of the agent sufficient to reduce the numbers of or kill bacteria, mycobacteria, viruses, mold, fungi, spores, biofilms, or other pathogenic species. The minimum concentration to kill a microbe (e.g., minimum bactericidal concentration (MBC) for bacteria), is the concentration of the antimicrobial agent expressed in mg/liter or μg/liter required to kill the microbe. One measure of reduction is to express the decrease in population in logarithmic scale typical of a specific microbial species. That is, a ‘1 log reduction’ is equivalent to a 90% reduction versus a control, a ‘2 log reduction’ is a 99% reduction, and a ‘3 log reduction’ is 99.9% reduction, etc.

The term “binder” relates to materials which are used to provide a matrix to contain the antimicrobial materials. These binders may be thermoplastic or thermosetting polymers or may be inorganic materials. Generally, these binders are added to the coating formulations as aqueous emulsions or suspensions or water-soluble solutions. These binders may also be added as monomers which are polymerized (including crosslinking) to produce the final coating. The binder helps form a coating, provides coating integrity, and reduces the amount of antimicrobial material extracted from the coating when exposed to water and/or other solvents. The binder is usually selected such that it is compatible with the surface of the antimicrobial particles, and/or the surface functionalizing agents used on the particles, and/or the water-soluble polymer (if used) in the coating formulation. A binder may also assist in film formation and/or promote adhesion to the substrate. Since, a focus of this invention is to form adherent and durable coatings on hydrophobic substrates, where such coatings are deposited from aqueous solutions, the selection of binders which can be deposited from water and then have good film forming abilities and adhesion is important. As an example, for coating polyolefin based materials, a binder is a copolymer of hydrocarbons (e.g., ethylene, propylene, butylene, etc.) and a water soluble or miscible monomer. Another one would be for example a vinyl pyrrolidone based polymer where some of the side chains are alkylated (e.g., Agrimer™ polymers). Depending on the relative amounts of the two within the copolymer, this copolymer may be water soluble or may have to be introduced in the aqueous coating solution as an emulsion. This copolymer may be a random copolymer, block copolymer or a graft copolymer.

The term “coating formulation” or “formulation” refers to a liquid composition used to deposit the coatings. These will constitute antimicrobial particles suspended in a liquid medium with other components as laid out in this disclosure. This liquid medium may be aqueous and may contain other volatile materials. The coating formulation composition is dependent on the substrate being coated and the end-application. The other ingredients may include surfactants, adhesion promoters, monomers (that may also form crosslinks), polymerization agents (initiators and catalysts), crosslinking agents, polymers (soluble in the aqueous media or present as emulsions) as film formers and viscosity modifiers, co-solvents, additional antimicrobial materials, colorants (dyes and pigments), defoamers, fillers to provide certain optical and flow properties (e.g., titania particles and fumed metal oxides), antioxidants, reducing agents, thermal and UV stabilizers, compatibilizing agents, pH modifiers, etc. The coating formulation must wet the surface it is to be coated on.

The term “compatibilizing agent” refers to a compound which may be introduced to promote compatibility of otherwise immiscible materials in a coating formulation. One class of such compatibilizing agents is in the form of block copolymers of the individual polymers which are blended; for example, the Pluronic® line of triblock copolymers consisting of polyethylene oxide-polypropylene oxide-polyethylene oxide blocks. As this example shows, some compatibilizing agents may also fall under the classification of “amphiphilic polymer”, as polyethylene oxide is hydrophilic and polypropylene oxide is hydrophobic.

A “copper halide salt” is a member of the copper metal family combined with any of the halides, typically defined in the Periodic Table of the Elements as fluorine, chlorine, bromine, and iodine. Of these, preferred embodiments of the invention commonly include iodide, bromide, and chloride. Copper halide salts may include both copper (I) and copper (II) salts, for example, CuCl and CuCl₂ respectively. Of these CuCl has low water solubility and CuCl₂ has high water solubility. Of these forms, cuprous salts are preferred for their antimicrobial activity. Some examples of preferred cuprous salts are CuCl and CuI

The term “emulsion” refers to suspensions where one or more water-insoluble polymers are dispersed in water (or aqueous media) through the use of surfactants, amphiphilic polymers, or copolymers of such.

The term “film-forming polymer” refers to any of those polymers which, when dried from liquid formulations, form a continuous film or coating. Typical film forming polymers include water soluble and water insoluble polymers. These include but are not restricted to polyvinylpyrrolidone, chitosan, acrylates, polyolefins, polyesters and copolymers of such. These may be soluble in the formulation liquids or present as an emulsion. These may also fall under the definition of “binders” as used herein.

The term “functionalization” means modification of the surface of the particles with “functionalizing agent(s)” to effectuate any one or more of the following: 1) improve their interaction with other materials, especially with microbial species, 2) improve their interaction and uniformity of distribution with constituents of coatings and bulk materials, and 3) provide increased stability for the particles dispersed in liquid suspension (e.g., coating formulation). The term “functionalizing agent(s)” may include in a first embodiment a variety of polymeric species, such as polyvinyl pyrrolidone (PVP), polyethylene glycol (PEG), polyurethane polymers, acrylic polymers, polymers with ionic moieties, polyvinyl acetate, and copolymers of such. The functionalizing agent(s) may also play additional roles, such as to modify the pH of the solution and hence bind differently to the particles, or to act as reducing agents (as in the case of PVP). The polymers may be water soluble or water insoluble (in the latter case functionalization may be carried out in aqueous emulsions or in solvents). Functionalization may also be carried out in a second embodiment using small molecule (non-polymeric) species such as amino acids (or combinations of amino acids), peptides and polypeptides. In a third embodiment thiols (or combinations of thiols) also have demonstrated utility. Other embodiments include carbohydrates, glycols, esters, silanes, surfactants, monomers and their combinations. In yet another embodiment, functionalization may refer to adding a ligand or group of ligands to the particle so that it specifically binds to a receptor or other biological target on a microbe. One may also carry out functionalization with combinations of functionalizing agents in the same formulation to effect a targeted approach against a specific genus and/or species of microbes.

The term “hydrophobic surface” is used to refer to solid surfaces of materials where deionized water makes a contact angle of 90 degrees or more. The term “hydrophilic surface” is also used to refer to those surfaces which do not fall under this definition of hydrophobic. Since the contact angles are difficult to establish on porous products such as fabrics (e.g., mats, woven, knitted, and non-woven fabrics), it is preferred to establish the contact angles on smooth solid surfaces made out of the same materials. In another method for establishing hydrophobicity for porous substrates, droplets of deionized water are placed on such surfaces and when water does not soak into the fabric (or other porous substrate), and instead beads on the surface, then it shows that the surface is hydrophobic. To quantify this definition of hydrophobicity on porous surfaces (including the surfaces of fabrics) if the deionized water bead stays longer than about 10 seconds, without noticeable spreading/soaking into the fabric, then this is taken as a sign of hydrophobicity of the substrate. In another embodiment this time period is longer than about 30 seconds. Some examples of hydrophobic surfaces include polyolefins including polypropylene (isotactic and syndiotactic, etc.,) and polyethylene (high density, low density, linear low density, etc.); polyethylene terephthalate; polystyrene; and certain polyurethanes, and fabrics made using fibers of these materials. Materials also exhibit different levels of hydrophobicity, e.g., polyolefins are far more hydrophobic as compared to polyethylene terephthalate. Some examples of hydrophilic (non-hydrophobic) surfaces include cellulose (e.g., cotton), rayon, keratin (e.g., wool), fibroin, soda-lime glasses, ceramics, Nylon 6, etc., and like hydrophobic materials these also exhibit different levels of hydrophilicity.

The “substrates” for coating may be non-porous solid articles in different forms (sheets, tubes, rods and 3-d shaped articles) made out of polymers, metals, ceramics, glasses, non-porous natural or polished stones, etc. These substrates may also be porous materials selected from the above material classes and include including yarns, fabrics, mats, foamed articles (rigid and flexible). For example, porous substrates are typically used for masks and various clothing for personal protection wear; air-filters; wound dressings; diapers; textiles including bedding and furniture coverings; towels; undergarments; and socks; upholstery, carpets and disposable tissue papers.

The terms “antimicrobial metal compounds [with low water solubility]” or “low water solubility” are used herein to refer to metal compounds with a solubility lower than 100 mg/liter (and preferably less than 15 mg/liter) at room temperature (e.g., 25° C.). This antimicrobial effect may be due to the release or production of antimicrobial constituents (e.g. antimicrobial metal cations) when placed in a suitable environment (e.g. aqueous). For example, copper salts release copper ions that may interact with microbes in the surrounding environment, causing cell death, cell wall failure, etc. Through this mechanism, metal compounds with particularly low water solubility have been found to provide antimicrobial activity over a long period of time. The antimicrobial metals of interest include copper, zinc and silver. Some specific metal compounds which have low water solubility are cuprous iodide, cuprous chloride, cuprous oxide, cuprous acetate, cuprous thiocyanate, silver chloride, silver bromide, silver iodide, zinc oxide and zinc pyrithione. Some extent of water solubility (at room temperature) is desired so that the antimicrobial effect does not require physical contact of the microbes with the particles. In one embodiment, this solubility should be greater than 1 μg/liter and in another embodiment greater than 10 μg/liter. In some cases, the entire AM compound or antimicrobial agent may be released.

The term “highly water-soluble salts” is used to refer to select water-soluble salts which have water solubilities in excess of 100 mg/liter at room temperature (e.g., 25° C.). Such salts may be optionally introduced for various purposes—e.g., as dispersal aids in the preparation of the formulations used herein. The addition of water-soluble salts with antimicrobial properties may also help in providing antimicrobial efficacy at different time points (e.g., a burst of activity at shorter times), provide buffering effects, aid control of the redox properties of the ions (e.g., stabilizing cuprous ions, aid in stabilizing iodide ions in compositions comprising cuprous and/or iodide ions), or provide compatibility with other ingredients in the composition.

The term “monomers” includes those materials which have the ability to form polymers with or without other co-monomers. These may also bond to the surfaces of the particles as functionalizing agents. The monomers may also be used in the coating formulations to form polymer matrix. These may also react with the functionalizing agents Some examples of monomers are glycols, silanes, metal alkoxides, acrylic polyols, methacrylic polyols, amino acids, glycidyl esters (e.g., epoxies), vinyl, epoxy, styrenes, isocyanates (including blocked isocyanates), acrylics and methacrylics.

The terms “polymerization agent”, and/or “polymerization initiator” are used to refer to a compound which is used to initiate a polymerization reaction, including those reactions which would lead to crosslinking within or between polymeric chains. These may be initiated through a thermal or UV process, providing polymerization through mechanisms such as free radical, condensation, or ionic polymerization.

The term “stable formulation” is used to describe a liquid coating formulation or aqueous suspension of antimicrobial particles wherein the particles are uniformly dispersed or suspended. Agglomeration and/or settling out of suspension is inhibited by stabilizing the particles through surface modification and/or use of other additives (e.g., surfactants, compatibilizing agents). The stability of a suspension may be measured according to its “shelf life”; the time period over which there is no appreciable settling out of the metal compound from suspension. Stabilized particles of a given metal compound have a longer shelf life as compared to particles of similar shape and size which are not stabilized. Typically, shelf life may be measured and compared for suspensions of particles that exhibit similar sizes, geometries, solvents, and concentrations. Even for stabilized particles, the shelf life of larger particles may be lower than the shelf life of the smaller particles. It should be noted that in some cases a few large particles are formed which may settle fast. However, as long as appreciable amounts (greater than 25%) by volume or by weight of the particles remain dispersed, that would still be a stable suspension that can be re-dispersed under stirring conditions. In another embodiment this amount is greater than 50%, and yet in another embodiment this is greater than 75%. Shelf lives preferably of at least eight hours, more preferably at least 30 days, and most preferably at least 180 days are contemplated for the aqueous suspensions and coating formulations of the invention herein.

The term “surfactants” means nonionic, cationic, anionic, or amphoteric surfactants. A large variety of surfactants are commercially available. Some specific examples are Brij™, Tween®, Triton™ X-100, Capstone™ FS-31, Sodium dodecyl sulfate (SDS), cetyltrimethylammonium chloride or cetyltrimethylammonium bromide (CTAB). Also included are “gemini surfactants”; a class of novel surfactants with more than one hydrophilic head group and hydrophobic tail group linked by a spacer generally at or near the head groups. The spacer may be either hydrophobic or hydrophilic and may be rigid or flexible. These may still also be classified as cationic, anionic, etc.

The term “volatile materials”, or “VOCs” are solvents and additives that have boiling points less than about 220° C., as these materials will be removed during processing and any remnants will continue to leave the coatings slowly as coated products are stored. Monomers are not considered as volatile even if their boiling point is lower than 220° C. even though some of them may be lost during processing, as long as these monomers form polymeric materials upon polymerization, which do not boil at temperatures less than 220° C.

The term “grammage” or “GSM” may be used as shorthand to refer to weight normalized by the product's area (e.g. fabric area), in grams per square meter. This is relevant in cases where the substrate may be a fabric (woven, knitted or non-woven, etc), such that the relative mass of various fabrics and the amount of coating applied may be compared more easily between samples of fabric with different areas.

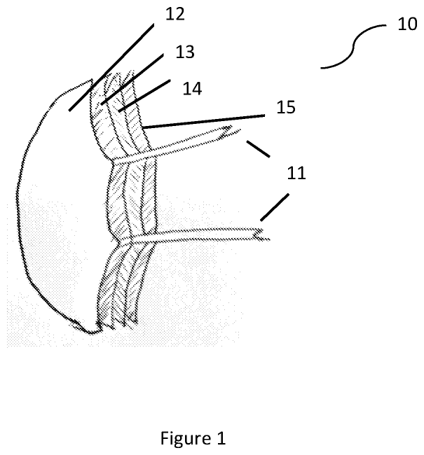

FIG. 1 shows an example of a product enabled by the present teachings. This figure schematically shows a four layer face mask 10, where the four layers 12, 13, 14 and 15 are shown in a blown diagram, and the straps to hold the mask on the face are shown as 11. All of the layers in the mask may be made of non-woven polypropylene. In this mask the outer layer 12 may be coated as taught in this invention with coatings containing low water solubility copper compounds, layers 13 and 14 (or both) may be high efficiency electrostatic filters to remove small particles (e.g., as in a commonly used N95 mask), and the last layer may have a softer feel as it contacts the face. The air that contacts the front layer (or any fluids such as saliva (e.g., spit) or blood or other mucus that contacts the outer surface, and the antimicrobial agent immediately reacts to neutralize the microbes. The masks may have different number of layers, and also use different materials in each layer. The coatings may just be on the outer layer or in several layers including or excluding the outer layer. In one embodiment in a four layer mask the coatings taught here may be on layers 12 and 14.

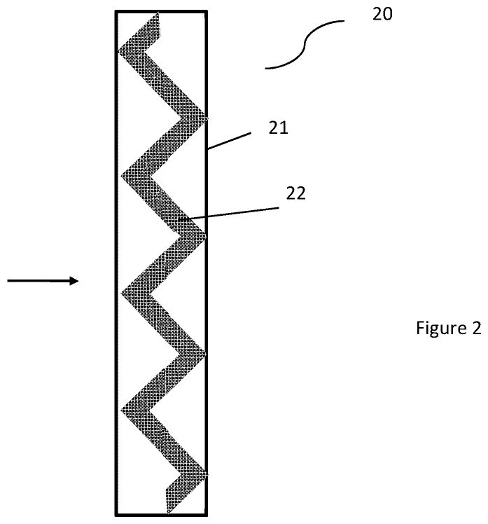

FIG. 2 shows a pleated filter 20 for use in buildings or transportation (e.g., as cabin filters). These pleats may be of one fabric layer or several layers of fabrics which are fused or held together. The direction of air flow is shown by the arrow. The pleats are shown as 22 and the filter housing as 21. The fabric of the pleat or at least one of the layers in the pleat fabric (if this contains multiple layers) is hydrophobic and coated with coatings containing low water solubility copper compounds as taught here. This is only one example, however, numerous types of filter constructions may be used. A filter might comprise of several filters or layers brought together in a common housing, and in that case at least one of the layers is coated according to the teachings here.

The above products provide antimicrobial properties and may also provide other benefits of removing airborne contaminants.

The coating formulations of the present invention contain particles of antimicrobial (AM) metal compounds which have low water solubility. Aqueous coating formulations are used due to their attractive economic aspects, and also because they are safer in transportation, handling and processing. In order to make stabilized formulations and impart other desirable characteristics to the formulations and the coatings, the surfaces of these particles are modified. These may be modified with a variety of materials including polymers, copolymers, monomers, surfactants and/or other organic materials with a molecular weight of at least 60. Procedures regarding surface modification of the antimicrobial particles used herein are disclosed in U.S. Pat. No. 9,155,310, the disclosure of which is incorporated herein by reference in its entirety for all purposes.

In U.S. Pat. No. 9,155,310, the authors discussed methods for manufacturing antimicrobial particles of certain metal compounds that are fast-acting and exhibit broad-spectrum efficacy when incorporated into coatings according to teachings referenced therein. The particles described involve the use of one or more of metal compounds which demonstrate antimicrobial properties, particularly compounds of copper, silver, zinc, molybdenum and tungsten. In one embodiment, these are salts of these metals. In another embodiment, these are oxides of these metals. The antimicrobial compounds used as particulates in these formulations have a water solubility of less than 100 mg/liter. Some specific materials include cuprous iodide, cuprous chloride, cuprous oxide, cuprous acetate, cuprous thiocyanate, silver chloride, silver bromide, silver iodide, zinc oxide and zinc pyrithione. These materials may be used alone, in combination with each other, and/or in combination with antimicrobial materials other than those mentioned and/or with antibiotics (for an additional or broader AM effect). In another embodiment, the pH of aqueous formulations with cuprous salts is from about 3.5 to 9.5, and in another embodiment between 3.5 and 7.5.

In one embodiment, the average particle size of the antimicrobial materials is in the “nano” range, while in another embodiment it is in the “micro” range. Smaller particle sizes in general may be preferred for certain applications. For some applications, smaller particles are desired such that, for the same weight fraction of AM material in a coating, there are more particles providing a smaller interparticle distance. In addition, the amounts of AM constituents released will be higher for smaller particles when they are present in the same concentration due to their higher surface area. On the other hand, larger sized particles are more difficult to get airborne and thus safer to handle. In addition, larger particles exhibit more shallow penetration into the lungs of individuals. For this reason, in many applications, micro sized particles are preferred. In many applications, the average particle size is in the micro range, with additional specifications such as the percentage of particles not to exceed a certain size and/or not to be smaller than certain size. Examples of such specifications were provided earlier when defining nano and micro sized particles. The formulations may also include other classes of AM materials selected from AM agents, antibiotics and antiviral agents. One such class of AM materials that may be employed are quaternary ammonium salts such as silicone alkyl ammonium salts. In another example, polymers or polymers containing groups which have been shown to exhibit AM activity may be introduced, such as polyguanidines, polyethyleneimine, and chitosan. The formulations may also comprise highly water-soluble salts, and in some embodiments the anions of these salts may be the same as for the AM salts such as metal halides.

In one embodiment, the AM particles may be surface modified using at least one polymer (including copolymers) or surfactant(s). Additional polymers (including those that are water soluble) and surfactants may also be added to the coating formulation. Some examples of water-soluble polymers and copolymers are those made from monomers that comprise at least one of vinyl pyrrolidone, ethylene oxide, vinyl acetate and acrylic acid. In other embodiments, other functionalization agents may be employed as discussed in paragraph [0030] above.

Some challenges associated with using aqueous coating formulations on hydrophobic surfaces include 1) proper wetting of the formulation and 2) retaining adequate adhesion of the coating to the substrate after the solvent is removed. Surfactants are widely used to improve the wetting behavior of aqueous formulations; however, this is often not sufficient alone as the coatings must also have good adhesion, and in some cases certain surfactants are even ineffective in improving wetting of the substrate. In some cases, the surfactants impair the adhesion of the coatings: their selection has to be compatible with the other materials used, including adhesion promoters and/or binders used in the coatings. These may be different from or the same as the surfactants used to modify the AM particle surfaces. These surfactants may be nonionic, anionic, or cationic. In one preferred embodiment a nonionic and anionic surfactant may be used in combination. In another embodiment, it has been found that certain Gemini surfactants are useful in these formulations is important. Unique properties of Gemini surfactants, such as low critical micelle concentration, good water solubility, unusual micelle structures and aggregation behavior, high efficiency in reducing interfacial tension, and desirable rheological properties in terms of reducing both static and dynamic surface tension, contribute to improved coatability of formulations when Gemini surfactants are present. It has also been found that mixing different classes of surfactants may lead to improvements in formulation coatability. In one embodiment, it was found that a combination of several Gemini surfactants and a combination of at least one Gemini surfactant and at least one anionic surfactant led to substantially improved wetting characteristics.

The formulations further comprise binders which are not easily removed, the purpose of which is to help retain the particles within the coatings when the final objects come in contact with water (e.g., rain), other body fluids, or when the air flows through them (e.g., coated fabrics and porous bodies). In another embodiment the flow of fluids and air may also be blocked. Hydrophobic polymers themselves are not water soluble but instead their aqueous emulsions are used in the formulation. When the solvents are removed from the coating, particles in the emulsion coalesce and form a water-insoluble layer. A water-insoluble polymer as referred to herein has a solubility in water of less than 100 mg/liter. In one embodiment, the hydrophobic polymers may be selected from acrylic, methacrylic, polyester, polyether, polyurethane, epoxy, silicone, polyolefin, polystyrene, polyvinyl acetate, halogen-containing polymers, or copolymers containing at least one of these. It should be remarked that the above classes of polymers (depending on their detailed chemistry) may also have hydrophilic groups (as copolymers of hydrophilic and hydrophobic copolymers), and may also be used for surface functionalization.

A particularly useful class of binders for hydrophobic surfaces, such as polypropylene and polyesters are copolymers of hydrophilic and hydrophobic materials. It must also be pointed out that polypropylene is much more hydrophobic as compared to polyester, and a coating/binder suitable for polyester would not be appropriate for polypropylene and vice versa. Materials for coatings and coating formulations have to be determined for each type of fabric material, and in this application, a considerable focus is placed on polypropylene. One example of a binder suitable for polypropylene is a copolymer of polypropylene and maleic anhydride. Sometimes these may also be chlorinated to provide more polarity. In one embodiment maleic anhydride is grafted on to a polypropylene polymer chain. In water, some or all of the anhydride may be converted to maleic acid. These copolymers have good affinity towards polypropylene after the solvents are evaporated. These are also dispersible in solution or as emulsion in water depending on the maleic anhydride content relative to polypropylene in this copolymer. It is preferred that those binders are used where the polymer may be dispersed in water as emulsion (not as a solution), so that after water evaporates the dried polymer is not soluble in water. This allows adherent and durable coatings to be formed from aqueous media, even though the coatings may absorb some water. As another example, a copolymer of vinyl acetate (VA) and vinyl pyrrolidone (VP) is water soluble when VP is 60% or more (by mole fraction). Thus, for this type of copolymer to be used as a binder for an appropriate water-resistant coating, it is preferred that the VP content is 50% or lower (by mole fraction). Furthermore, for the matrix forming the coating (after drying), to have water resistant properties, the amount of water-resistant polymer can be changed. Adherent coatings with different levels of water resistance may be obtained. The volume % of the water insoluble should exceed 35% of the water-soluble components (e.g., a water-soluble polymer or a surfactant with large molecular weight that stays in the coating) plus any particles of low water solubility. In another embodiment the volume of the water insoluble polymer should be about 45% or more. and in another embodiment more than 55% (as compared to the water-soluble non-volatile components and the particles of low-water solubility, such as CuI). As is discussed later, in addition, the coating formulations must wet the substrate to form good coatings which have high performance and are safe.

In another embodiment, monomers and polymerization initiators or catalysts may be used to form binders which are polymerized during the process of the coating operation. The monomers (and polymerization initiators) may be water soluble or water insoluble but result in water-resistant polymers upon polymerization. This may be due to their inherent low water solubility or the formation of crosslinks which do not dissolve in water (imparting water-resistance). The polymerization may be cured thermally or by radiation (e.g., ultraviolet (UV) radiation).

In summary, we have developed coating formulations and the coatings produced therefrom. The antimicrobial metal compounds used herein typically generate antimicrobial effect in the proximity of a suitable environment (e.g. aqueous). To prolong the activity of these coatings, those antimicrobial compounds are selected which have a low solubility in water. It is preferred that the water solubility is less than 100 mg/liter, and more preferably less than 15 mg/liter. Low water-solubility is important because the rate at which antimicrobial constituents are released increases with increasing solubility of the parent material, thus a lower water solubility may be equated with longer-lasting antimicrobial efficacy. However, water-soluble monomers, polymers, or copolymers may also be present in the formulation. These may be used as functionalizing agents on the surface of selected metal compounds or may be added directly to the formulation. The water-soluble materials present in the finished coatings are used to provide an environment around the particles conducive to the release or formation of antimicrobial constituents. These constituents then undergo transport or diffusion through the coating in order to allow more effective interactions between the target microbe and antimicrobial compounds and their constituents. This is relevant because biological fluids, such as saliva, blood, and exhaled air, are all aqueous or humid. Surfactants are also an important component in the formulation—the coating must adequately wet the surface and spread evenly as to produce a uniform and smooth final coating. The purpose of surfactants as additives is to lower the surface tension of the formulation, allowing for easier wetting to low-surface-energy substrates (such as the hydrophobic PPE materials mentioned later). For those formulations which are designed to be used on a wide range of surfaces, surfactants are added for broader compatibility. Substantially improved wetting performance has been noted in preferred embodiments containing a combination of surfactants. These may be selected from different classes of surfactants or from the same class. In some formulations use of a Gemini type surfactant has been shown to be quite effective in reducing the dynamic surface tension. Dynamic surface tension is especially relevant during the coating operation due to the relative movement between the substrate and the coating formulation (fluid).

The binder comprises a thermoplastic polymer or a thermosetting polymer or inorganic material. The amount of binder used is such that after the formulation has been dried, cured, and/or crosslinked to produce a final solid coating, the volume of solids contributed by the binder exceeds 35% of the volume contributed by the other solid ingredients. In another embodiment, the volume of solids contributed by the binder exceeds 45% of the volume contributed by the other solid ingredients, and yet in another embodiment this is 55%. In another embodiment, the volume % of the binder in the coating should not exceed 80%, and yet in another embodiment should not exceed 99%. This is to ensure that the binder is able to retain the AM particles such that they are not easily removed (physically) in aqueous environments, but still allow AM constituents or agents to be transported to the microbes. In one embodiment the binder is a low water solubility thermoplastic polymer. This may be introduced in the coating formulation as a polymeric emulsion, monomeric emulsion, or solution which upon drying/polymerization during coating processing attains low water solubility. In another embodiment, the binder may be crosslinked and may be introduced in a monomeric form (or a polymer with polymerizable groups on the polymeric chain) along with a polymerization catalyst and/or initiator. During the coating process, this forms a crosslinked network. Even if these crosslinked networks exhibit some swelling (expansion) due to the uptake in moisture, they can still resist the removal of the complete AM particles from the coating.

The compositions or formulations are used to coat substrates. In one embodiment, these substrates may be solid bodies or fabrics including woven, knitted and non-woven fabrics. In another embodiment methods are described to form coatings on such fabrics, particularly to form antimicrobial face masks, respirators, and other personal protection equipment (PPE) including gloves, gowns, head coverings, etc. In some cases, the coatings may also be transparent and used to coat plastic face shields which are transparent. Some of the hydrophobic materials (or fibers) used to make the masks and PPE include polyolefins, acrylics and polyesters (such as polyethylene, polypropylene, silk, copolymers of polyacrylonitrile and polyethylene terephthalate). Sometimes fibers from these materials may be blended with other fibers which may be hydrophilic (e.g., wool, cotton, nylon, rayon, etc.).

The weight increase of coated fabrics (after removing volatile components, such as solvents used for processing) is about 0.1% to 25% by weight based on the uncoated fabric weight. Volatile materials are solvents and additives that have boiling points less than about 220° C., as these materials will be removed during processing and any remnants may continue to leave the coatings slowly. This does not include monomers as they are typically polymerized during processing to form materials that do not volatilize at these temperatures. In one embodiment, the coating itself (after drying) which demonstrates high antimicrobial efficacy has about 0.1% to 70% by weight of the antimicrobial agent, and in another embodiment this number is between 0.2% to 25% and yet in another embodiment this is between 0.25% to 20% by weight. For example, a coating containing cuprous iodide will have 0.1 to 70%, 0.22 to 25% or 0.25 to 20% of copper iodide by weight according to the above embodiments.

For use in masks, respirators, and air-filters, the air flow rate (or pressure drop for an equivalent amount of flow) through the coated fabrics should not change by more than a factor of 5 as compared to the non-coated fabrics. In another embodiment, this factor should be less than 3. For use in gowns, one may use coatings which have similar characteristics. In other examples, depending on the objective, the gown coatings may substantially block water and air flow in order to provide superior permeability resistance and block the microbes passing through. The weight percent of surfactants in the coating formulation is usually between 0.001 to 5% by weight of the total formulation. In another embodiment, this percent may be between 0.01 and 3% by weight of the total formulation. The aqueous formulations may also contain other co-solvents which are soluble in water and assist with processability such as change in surface tension, viscosity, drying rate, and help solubilize other materials. Some examples are ethanol, acetone, methyl ethyl ketone and non-ionic surfactants which have a boiling point of less than 220° C.

It is important for many applications that a high kill rate of the microbe is achieved, while maintaining safety (i.e., health safety for humans). Thus, the type of coatings, the type of antimicrobial agent, surface functionalization, its concentration, coating matrix and its way of incorporation all should lead to high antimicrobial efficacy and still be safe for a person in contact with this article. The efficacy may vary for the microbes, here in several of the examples a model microbe selected was MS2. MS2 is a single stranded RNA virus that infects and kills Enterobacteria. This virus is generally regarded as harder to kill than corona viruses. To establish the performance of high-quality coatings, the following embodiments are defined. It must be noted that just because two coating have the same active ingredients in the same concentrations does not imply that the coatings will produce identical performance. In one embodiment the kill rate should exceed 99.9% (or log₁₀ reduction of 3) in 15 minutes or less of contact time between a coated surface and the microbe, in another embodiment this reduction should be achieved in 5 minutes or less and yet in another embodiment this should be achieved in 1 minute or less. Many of these applications are listed in Table 1 which includes articles which are frequently touched by many people, or those where air is rapidly flowing through, and contact period is limited or even those where the microbe may multiply rapidly if it is not killed immediately. Some examples from this table are face masks, certain medical applications air-filters, and other hospital wear. In some instances, the article may comprise several components or layers and only some of them may be coated. For safety, the antimicrobial (AM) agent should not be easily extracted from the article mechanically or by contact with an aqueous medium, as that can cause easy transference of the material by ingestion, inhalation or by touch. Also, since some of these protective products may be worn by the user for long time (e.g., over an eight-hour shift), and the microbe along with aqueous medium (e.g., spit, sweat, nasal mucus, blood, etc.) may land on the same spot again and again, and if the coating is removed or antimicrobial agent in that area becomes ineffective due to the first landing, then that area would become ineffective to kill the microbe when it lands in the same spot again. Thus, in one embodiment, coating tested for efficacy in a challenge test at the same coated spot three consecutive times will still reveal the same level of efficacy as discussed above (i.e., each time, the kill rate should exceed 99.9% for MS2 in 15 minutes or less of contact time) or better. Again, the level of quality of the coatings must be able to meet such a standard, that it is not washed with repeated testing or show lesser effectiveness.

In one embodiment, the solids content of the coating formulations typically varies between 0.02% to 15% by weight. In another embodiment, the solids content (including monomers if present) is between 0.1% to 5% by weight. This means that the balance of the materials in the coating formulation are removable (volatile materials, including water).

The range by weight of the solid content of the coating for the surface modifiers and water-soluble polymers is 0.5 to 35% and of the binder is 2% to 60%. The binder may be a polymeric material or may be a monomer along with polymerization initiator or catalyst. There may be several water-soluble polymers used in the formulation and also more than one polymer and monomer in the binder.

In a specific embodiment for mask, respirator, and air filter formulations comprising CuI as an antimicrobial agent, its concentration by weight in the coating (after removal of volatiles) is in the range of 0.1-70% by weight. The water-soluble polymer weight percentage for this coating is in the range of 1-45%, and for the binder the range is 15 to 60%. For gowns where a longer contact time of a microbe may be tolerated for it to be killed and the coating often has to increase the water permeability resistance of the fabric, the concentration of CuI in the coating (after removing the volatiles) is in the range of 0.5 to 10%, water soluble polymer in the range of 0.05 to 10% and the water insoluble polymer in the range of 10 to 90% (all by weight).

This invention is concerned with the production of coating formulations incorporating one or more metal compounds with AM properties, the application of such formulations to surfaces, the resulting solid coatings, the coated products so produced and the processes of their manufacture. In one embodiment, the antimicrobial compounds having low water solubility are incorporated as particles. In another embodiment these particles may be surface functionalized. These surfaces may be solid bodies or fabrics including woven, knitted and non-woven fabrics. Furthermore, these solid surfaces may be porous, semi-porous or impermeable bodies. The methods are described to form coatings on fabrics, particularly where the coated fabrics are used to form antimicrobial face masks, respirators, and other personal protection equipment (PPE) including gloves, gowns, and head coverings. Some of the hydrophobic materials used to make the masks and PPE include polyolefins, acrylics and polyesters (These include polymers such as polyethylene, polypropylene, polymers and copolymers of polyacrylonitrile and polyethylene terephthalate). Sometimes hydrophobic fibers may be blended with other fibers which are not hydrophobic (e.g., wool, cotton, nylon, rayon, etc.). These compositions may also be used to coat mats and fabrics used to make air-filters for use in air purifiers, transportation (cars, buses, trains, boats, planes) and in buildings and also in associated HVAC systems.

In addition to their outstanding antimicrobial properties, many of the compositions of the present invention also have usefulness for reducing inhaled airborne pollutants. Nien O et al. in U.S. Pat. No. 10,617,894, for example, teach that pollutants such as oxidizing gases—especially nitrogen dioxide, sulfur dioxide and ozone—can be reduced by masks containing coatings which include cuprous iodide, iron phthalocyanine and a binder of polyvinylpyrrolidone or polyvinyl alcohol. Optionally, a humectant may be included in the coating formulation.

The cuprous iodide particles in the coating formulations of Nien O et al. are relatively coarse, with mesh sizes of 50 to 300 microns, and are not surface functionalized. In addition, unlike the insoluble binders of the present invention, their binders are highly water soluble. Further, while they mention that their coatings may be applied to polyester or polypropylene textiles, their detailed teaching relating to masks is directed exclusively to coating polyester. Their polyvinylpyrrolidone binder is suggested to trap molecular iodine produced by the reaction of cuprous iodide with oxidizing gases and prevent the iodine from entering the airstream.

Using the present invention with functionalized particles of copper iodide, it should still be possible to trap any molecular iodine produced in reaction with oxidizing gases. Such trapping can be provided by including polyvinylpyrrolidone (PVP) as the functionalizing agent and/or by using a water insoluble PVP copolymer or using other water insoluble binders taught herein. With PVP included in the functionalizing agent, the trapping of any molecular iodine should be more effective than using a binder of PVP, since the iodine-trapping polymer is provided in intimate contact with the CuI particles. Further, this invention can provide coated fabrics and products using these fabrics which have both types of properties, i.e., antimicrobial properties and also properties for reducing airborne pollutants.

In addition, the use of insoluble binders provides great advantages over soluble binders, particularly in applications such as masks and other personal protective equipment which are exposed to water in the environment—and in the case of masks, to water from the wearer's breath.

It should be further noted, that a products having antimicrobial properties as taught herein with improved coatings quality and some water resistance may also possess additional properties which reduce pollutants from being dislodged from the coatings and being inhaled.

In some non-limiting aspects, the present disclosure includes the following methods:
1. A method of forming a solid coating with antimicrobial properties comprising depositing an aqueous-based formulation on a fabric, wherein the formulation comprises in an aqueous-based medium:
   a) particles of a metal compound having water solubility of less than 100 mg/liter, the said particles or a constituent of the said particles having antimicrobial properties;
   b) at least one of a water-soluble polymer and a surfactant; and
   c) at least one binder comprising a water dispersible emulsion of a water-insoluble polymer,
and evaporating the aqueous-based medium or allowing the aqueous-based medium to evaporate to form the solid coating,
wherein the volume fraction of the water-insoluble polymer in the coating after drying is greater than about 35%.
2. The method of item 1, wherein the particles are chemically modified on their surfaces.
3. The method of item 1, wherein the particles comprise one or more cuprous compounds, silver compounds, zinc compounds, or a combination thereof.
4. The method of items 1-3, wherein the fabric is a non-woven fabric.
5. The method of items 1-3, wherein the fabric comprises hydrophobic fibers.
6. The method of items 1-3, wherein the fabric is in an article of personal protection equipment.
7. The method of item 6, wherein the personal protection equipment is a mask.
8. The method of items 1-3, wherein the particles comprise at least one of cuprous iodide, cuprous chloride, cuprous oxide, cuprous acetate, cuprous thiocyanate, silver chloride, silver bromide, silver iodide, zinc oxide, zinc pyrithione, or a combination thereof.
9. The method of item 1, wherein the said water-soluble polymer comprises a polymer or copolymer containing at least one of polyethylene oxide and polyvinyl pyrrolidone.
10. The method of item 1, wherein the binder comprises a polymer selected from a least one of an acrylic, methacrylic, polyester, polyether, polyurethane, epoxy, silicone, polyolefin, polystyrene, polyvinyl acetate or halogen-containing polymer or a copolymer containing at least one of these.
11. The method of item 1, wherein the surfactant is present and is at least one of non-ionic and anionic surfactants.
12. The method of item 1, wherein the solid coating additionally contains at least one of another antimicrobial material, an antibiotic and an antiviral agent.
13. The method of item 1, wherein the aqueous-based formulation has a pH in the range of 3.5 to 9.5.
14. The method of item 1, wherein the said particles have an average particle size in the range of 4 nm to 2,000 nm.
15. A method of forming a coating with antimicrobial properties comprising depositing an aqueous-based coating formulation on a substrate, wherein the formulation comprises;
a) particles of a metal compound having a water solubility less than 100 mg/liter, the said particles or a constituent of the said particles having antimicrobial properties;
b) at least one of a water-soluble polymer and a surfactant;
c) at least one binder comprising at least one monomer and at least one polymerization agent, wherein the polymer such formed has low water-solubility.
16. The method of item 15, wherein the coating formulation has a pH in the range of 3.5 to 9.5.
17. The method of item 15, wherein the coating formulation additionally comprises at least one of another antimicrobial agent, an antibiotic and an antiviral agent.
18. The method of item 15, wherein the at least one monomer is polymerized by at least one of thermal and UV polymerization.
19. The method of item 15, wherein the at least one monomer contains at least one of an acrylate and a methacrylate.
20. The method of item 15, wherein the at least one monomer comprises a quaternary ammonium group.
21. The method of item 15, wherein the substrate is a fabric, an optically clear sheet, or a hard surface.
22. The method of item 21, wherein the fabric is a non-woven fabric.
23. The method of item 21, wherein the fabric comprises hydrophobic fibers.
24. The method of item 21, wherein the fabric is in an article of personal protection equipment.

### List of Chemicals Used:

1. Copper Iodide powder, (a) purity >99% (G Amphray Laboratories, Mumbai India and also (b) IODEAL brand (Ajay grade, >99% purity) from Ajay SQM group (Atlanta Ga.), particle size <106 μm.
2. Copolymer Vinyl acetate-Vinyl pyrrolidone (PVP-VA), Luviskol™ VA64 (BASF, Germany)
3. Dynol™ 800 (Non-ionic gemini surfactant, purchased from Evonik, Germany)
4. Dynol™ 360 (Non-ionic surfactant, purchased from Evonik, Germany)
5. Surfynol™ 2502 (Non-ionic gemini surfactant, purchased from Evonik, Germany)
6. Tegopren™ 5840 (Non-ionic silicone surfactant, purchased from Evonik, Germany)
7. Capstone FS-31, non-ionic fluorinated surfactant from Chemours, Wilmington, Del.
8. Advabond™ 7200 (emulsion of a chlorinated, maleic anhydride containing polyolefinic copolymer having 30% wt solids, purchased from Advanced Polymer Inc., Carlstadt, N.J.)
9. Advabond™ 7251 (emulsion of a chlorinated, maleic anhydride containing copolymer having 30% wt solids, purchased from Advanced Polymer Inc., Carlstadt, N.J.)
10. Advabond™ 7419 (emulsion of a polyolefinic copolymer with maleic anhydride having 25% wt solids, purchased from Advanced Polymer Inc., Carlstadt, N.J.)
11. Advabond™ 7498 (emulsion of a polyolefinic copolymer having 30% wt solids, purchased from Advanced Polymer Inc., Carlstadt, N.J.)
12. PRIEX® 20097 by BYK (Germany) is a polypropylene polymer with a high degree of maleic acid anhydride grafting.
13. Vazo™ 56 WSP (water soluble thermal polymerization initiator, purchased from Chemours, Wilmington, Del.)
14. Vazo™ 68 WSP (water soluble thermal polymerization initiator, purchased from Chemours, Wilmington, Del.)
15. Irgacure® 2959 (water soluble UV polymerization initiator, purchased from Ciba Specialty Chemicals, Switzerland)
16. Triton™ X-100 (Non-ionic surfactant, purchased from Sigma Aldrich #234729, St. Louis, Mo.)
17. SR 611 (alkoxylated tetrahydrofurfuryl acrylate monomer, purchased from Sartomer, Exton, Pa.)
18. SR 610 (polyethylene glycol diacrylate monomer, purchased from Sartomer, Exton, Pa.)
19. SR 644 (polypropylene glycol dimethacrylate monomer purchased from Sartomer, Exton, Pa.)
20. SR 9035 (ethoxylated trimethylolpropane triacrylate monomer, purchased from Sartomer, Exton, Pa.)
21. CN 704 (Acrylated polyester monomer, purchased from Sartomer, Exton, Pa.)
22. RayCryl™ 1850 (45% wt solids, acrylic polymer emulsion, purchased from Specialty Polymers, Woodburn, Oreg.)
23. RayCryl™ 918K (45% wt solids, acrylic polymer emulsion, purchased from Specialty Polymers, Woodburn, Oreg.)
24. RayCryl™ 1859 (55% wt solids, acrylic polymer emulsion, purchased from Specialty Polymers, Woodburn, Oreg.)
25. RayCat™ 65124 (31% wt solids, cationic acrylic polymer latex, purchased from Specialty Polymers, Woodburn, Oreg.)
26. RayFlex™ 55517 65 wt % solids, acrylic polymer emulsion, purchased from Specialty Polymers, Woodburn, Oreg.)
27. PVP-VA 1-535 (50% IPA solution of PVP-VA copolymer, purchased from Ashland Specialty Ingredients, Wilmington, Del.)
28. PVP-VA E-535 (50% Ethanol solution of PVP-VA copolymer, purchased from Ashland Specialty Ingredients, Wilmington, Del.)
29. PVP-VA W-635 (50% aqueous solution of PVP-VA copolymer, purchased from Ashland Specialty Ingredients, Wilmington, Del.)
30. PVP (Polyvinylpyrrolidone) LUVITEC® K17 from BASF, Germany
31. Polectron™ 430 (40% wt solids, polymeric emulsion purchased from Ashland Specialty Ingredients, Wilmington, Del.)
32. Gantrez™ ES-225 (50% ethanol solution of polyvinyl methyl ester-maleic anhydride copolymer, Ashland Specialty Ingredients, Wilmington, Del.)
33. Ganex™ copolymers of PVP and acrylates, from Ashland Specialty Ingredients, Wilmington, Del.
34. Agrimer™ AL alkylated vinyl pyrrolidone polymers, from Ashland Specialty Ingredients, Wilmington, Del.
35. Pluronic® L-31 (PEG-PPG-PEG Triblock copolymer, purchased from Sigma-Aldrich #435406, St. Louis, Mo.)
36. Pluronic® L-61 (PEG-PPG-PEG Triblock copolymer, purchased from Sigma-Aldrich #435422, St. Louis, Mo.)
37. Pluronic® 10R5 (PPG-PEG-PPG Triblock copolymer, purchased from Sigma-Aldrich #435473, St. Louis, Mo.)
38. Poly(ethylene glycol) diacrylate (monomer with a molecular weight Mn˜575, purchased from Sigma-Aldrich #437441, St. Louis, Mo.)
39. Sodium Chloride (BioXTra≥99.5%, (AT), Sigma Aldrich #S7653, St. Louis, Mo.)
40. Polypropylene (¼″ thick sheet stock, McMasterCarr #2898K13, Santa Fe Springs, Calif.)
41. Polypropylene Fabric, SSS nonwoven hydrophobic fabric (type S2501ZR1AA01A), obtained from Fitesa Inc (Simpsonville, S.C.).
42. Zinc Oxide (99.9%, <5 μm powder, Sigma-Aldrich #205532, St. Louis, Mo.)
43. Silver iodide powder (99% from Sigma-Aldrich #226823, St. Louis, Mo.)
44. Silver chloride powder (99% from Sigma-Aldrich #227927, St. Louis, Mo.)
45. Poly (acrylic acid) (Mᵥ˜450,000, Sigma-Aldrich #181285, St. Louis, Mo.)
46. Poly(acrylic acid, sodium salt) (Mw˜8000, 45 wt % in water, Sigma-Aldrich #416029, St. Louis, Mo.)
47. Bondthane™ UD 315, a aliphatic polyester polyurethane dispersion in water for coatings with solids content of 40%, Bond Polymers International, Seabrook, N.H.
48. Cottonseed oil (Glicks® Finest, obtained Amazon Inc.)

1. Methods Used for Deposition of Coatings, Testing of Formulations and Coatings and Testing of Antimicrobial Activity

a. Method of Coating Nonwoven Polypropylene Fabric

An uncoated fabric sample was cut to the desired size. The selected coating formulation was poured in a small tray in a volume large enough to submerge the sample fabric. When the fabric was fully wetted it was removed and passed through a pair of squeezing rollers. To control the coating amount on the fabric and for a given formulation, roller pressure, roller speed and the number of cycles (passes) was varied. These parameters are very dependent on the specific rollers used, and since different types of rollers were used in different experiments some of which were assembled at the laboratory, these details are not provided as these are simple parameters that can be tuned to get the desired coating amount. In some cases, a squeeze roller for fabrics following the guidelines of standard test method AATC92 (American Association of Textile Chemists, Research Tringle Park, N.C.) was used. This squeeze roller had a model number XHF-54 Lab Squeezer available from XH Instruments, China. The drying (or curing) conditions are provided in each of the examples with formulation details.

a. Method of Coating Solid Polypropylene Sheets

Sample sheets were produced by cutting sample pieces from a stock sheet of polypropylene. The surface of the sheet was washed clean using an aqueous laboratory detergent solution, rinsed with deionized water, and blow-dried.

Using a micropipette, 50-150 uL of the desired coating formulation was deposited on the surface. An adjustable film applicator (DoctorBlade™, purchased from Amazon, Seattle, Wash.) is set to the desired thickness and pulled from edge to edge, spreading the formulation uniformly across the sheet. The sheet was then subjected to the drying and/or curing steps described below. Fabrics coated with different formulations were dried differently the details of which are included with the formulations.

b. Testing Weight Gain of Coated Fabrics

Uncoated samples of fabric were cut to a standard size and their weight was recorded. After coating and drying (or curing) their weight was recorded again. This was used to calculate the % weight gain of the fabric. Weight of the coating in grams per square meter (or GSM), was calculated by simply noting an increase in weight of the fabric (after drying) and converting this weight gain for an area of one square meter of fabric.

c. Testing Adhesion of Coatings on Solid Polypropylene Sheets

Coating adhesion on polypropylene (solid) sheets was tested using standard test method ASTM D3359: “Standard Test Methods for Rating Adhesion by Tape Test”. Samples were scored twice in perpendicular directions using a tool with 10 notched teeth spaced 2 mm apart resulting in a 2-mm square grid pattern. A segment of tape (3M Scotch brand, Cat 600) was placed over the scored area and gently pressure applied to ensure good contact with the coating. The tape was then pulled back, applying a constant force at as close to 0 degrees as possible. Once the tape was fully removed the scored area was inspected under a magnifying glass. A rating was assigned to the coating according to ASTM D3359 classifications depending on the degree of which the coating was peeled off from the scored squares. This rating is between from 0B to 5B, where a score of OB is considered poor or no adhesion and a score of 5B is considered as good adhesion, with the others representing various degrees between the two extremes.

d. Testing Copper Extraction from Coated Fabric

In order to evaluate the concentration of copper extracted from the coating, two solutions were prepared, one polar and one nonpolar. The first medium was prepared by dissolving 0.9 g of sodium chloride in 100 mL of DI water. The second medium used was commercially purchased cottonseed oil. Duplicate samples of coated non-woven polypropylene (PP) fabric were prepared in a size of 4 cm×4 cm, then placed into glass bottles containing 2.6 mL of the respective salt solution or cottonseed oil. These bottles were then sealed with a rubber lid and supporting aluminum seal, then placed in a heated oven at 50° C. for 72 hours, followed by removal of the fabric. The extraction medium was analyzed for copper content using ICP instrumentation at the University of Arizona according to ISO 10993.

e. Testing Airflow of Fabrics

Coated and non-coated fabrics were analyzed for airflow (pressure drop) according to ASTM standard F2100-20. The instrument used was Qualitek (MR) Leak and Flow tester (from Uson Inc., Houston, Tex.) A flow rate of 85 L/min was used. The differential pressure drop (in mm of water) was recorded across the fabric placed in an opening of 2 inch in diameter. Five readings were recorded, and their average and SD were reported.

f. Testing Wettability of Coating Formulations and Other Liquids on Fabrics

In order to evaluate the wettability of a fluid on fabrics (coated or uncoated), samples were cut to a constant size of 5 cm×5 cm, then sandwiched between two flat square frames, and taped around the edges. The samples were then placed in a vice and a suspended pipette containing a test volume of 50 μL was placed at 1 cm above the fabric. The fluid test volume may contain one or more surfactant(s), a combination of solvents (e.g., water) and one or more surfactant(s), or a coating formulation. The pipette was quickly emptied, and the test volume was allowed to fully wet the fabric. Once no further spreading/wetting was observed, the dimensions of the wetted area and corresponding time to wet were recorded.

g. Testing Antimicrobial Activity

Antimicrobial testing on antimicrobial suspensions was conducted against coronavirus strain 229E, MS2 bacteriophage and the bacterium Pseudomonas aeruginosa. The purpose was to establish a broad-spectrum antimicrobial efficacy, to test temporal changes to antimicrobial efficacy if any. Since the coronavirus testing was more involved and took a long time to conduct the experiments, the antimicrobial activity against this was only tested in a few experiments, and the other testing was done against the bacteriophage MS2 and Pseudomonas aeruginosa. Maintenance of the microbes, and evaluation of antimicrobial properties against MS2 and Pseudomonas is described in detail in U.S. Pat. No. 9,155,310 which is included herein by reference.

### Testing of CuI Suspensions Against Coronavirus:

i. The experiment was conducted in 2-ml volumes of phosphate buffered saline (PBS; pH 7.4) in 5-ml snap-cap polystyrene tubes. The tubes contained approximately 2.0×10⁶ TCID₅₀/ml of human coronavirus strain 229E (ATCC #VR-740) and the polymer-stabilized CuI nanoparticle suspension (CuI-Sus-02) at final concentrations of either 60 ppm or 300 ppm Cu. Triplicate tubes were included for each test concentration. In addition, triplicate tubes containing the virus alone in PBS were included as positive controls.
ii. Immediately at the start of the experiment (time=0 minutes), 300 microliters were collected from the three positive control tubes and placed into separate volumes of 300 microliters of Dey-Engley (D/E) neutralizing broth. This was a dilution of 1:2.
iii. The inoculated 5-ml snap cap tubes were then placed on an orbital shaker with agitation (250 rpm) and incubated at room temperature (˜22° C.) for the remainder of the experiment.
iv. At exposure times of 2, 5, 15, and 60 minutes, etc., 300 microliter samples were removed from each tube (triplicate tubes with nanoparticles at both 60 and 300 ppm Cu and triplicate control tubes) and neutralized in separate 300-microliter volumes of D/E (1:2 dilution) as described previously.
v. Virus Quantification:
vi. Virus concentrations for each neutralized sample were quantified using the Reed-Muench method (Payment and Trudel 1993—Payment P, Trudel M. (1993) Isolation and identification of viruses. In Methods and Techniques in Virology. Payment P, Trudel M (eds.), pp. 32-33. New York: Marcel Dekker Inc).
vii. To determine the tissue culture infectious dose that affected 50% of the cultures (TCID₅₀). The samples were 10-fold serially diluted in cell culture minimal essential medium (MEM). The assay was performed in 96-well cell culture plates containing monolayers of MRC-5 cells (fetal human lung fibroblast; ATCC #CCL-171). Prior to the assay, the MRC-5 cells were rinsed gently twice with MEM and then the 96-well plates were inoculated with the diluted samples (6 wells inoculated with 50 microliters each per dilution) and the plates were incubated in an atmosphere of 5% CO₂ for 1 hour at 35° C. to allow the virus particles to adsorb to the cells.
viii. Note: Each 96-well plate also included 6 negative control wells containing cells only (no antimicrobials or virus) with 50 microliters of MEM added.
ix. Following this incubation period, 150 microliters of MEM containing 2% fetal bovine serum was added to each of the 96 wells and the plates were incubated in an atmosphere of 5% CO₂ for 6 days at 35° C.
x. The cells were observed daily for viral cytopathic effects (CPE) using an inverted microscope. The inoculated cells were compared to the negative control cells in the same 96-well plate to differentiate CPE caused by viral infection versus CPE caused by cell toxicity or potential contamination. Wells positive for viral CPE were considered positive for viral growth.
xi. Note: No CPE was observed in any of the negative control wells.
xii. After the incubation period, the TCID₅₀/ml was determined. Six wells per dilution were used to ensure adequate precision of the assay. The greatest dilution in which 50% or higher of the wells were positive was used to determine the virus TCID₅₀/ml following the method described by Payment and Trudel (1993).
xiii. The data were reported as the logarithmic reduction using the formula −log₁₀ (Nₜ/N₀), where No is the concentration of the recovered coronavirus at time=0 minutes and Nₜ is the concentration of the surviving coronavirus in the sample collected at time=t (i.e., 2, 5, 15, or 60 minutes).

### Testing Antimicrobial Activity of Coated Nonwoven Polypropylene Fabrics

Coated nonwoven polypropylene fabrics were analyzed for AM activity against MS-2 bacteriophage at the University of Arizona using a modified procedure selected from ISO 18184: “Determination of Antiviral Activity of Textile Products”. The modifications included:
i. Samples were neither washed nor autoclaved prior to testing.
ii. Fabric weights varied from 0.33 to 0.71 g; prioritized using fabrics weighing 0.40±0.5 g, as the method states.
iii. Human coronavirus 229E (ATCC #VR-740) or MS-2 bacteriophage (ATCC #15597-B1) were used in these tests rather than those called for in the standard.
iv. Dey/Engley neutralizing broth was employed in place of a SCDLP medium.
v. Neutralization of control fabrics with D/E neutralizing broth was performed with 4 mL, rather than 20 mL.

The population of the bacterial virus was measured against exposure time with the coating, producing a log₁₀ based reduction. The log₁₀ removal was collected at times ranging from 1 minute to 24 hours on both active and control fabrics.

The following examples are illustrations of the embodiments of the inventions discussed herein.

### Example 1: Preparation of Antimicrobial Suspensions

Antimicrobial (AM) suspensions containing particles of metal compounds with low water solubility were prepared by wet milling method disclosed in U.S. Pat. No. 9,155,310. Unless otherwise stated, these suspensions comprise a metal compound with low water solubility, functionalizing agent, and a highly water-soluble salt. For copper-iodide based suspensions in Table 2, the weight ratio of metal compound to the polymeric functionalizing agent (VA64) to the water-soluble salt (sodium iodide) used is 90:18:1 respectively, unless otherwise stated. For the silver iodide based suspension the ratio of AgI:VA64:NaI was 90:20:1

These suspensions are produced in a range of sizes depending on the final application with certain requirements on average particle size and distribution of the particle size. Suspensions may fall under the definitions of “micro” and “nano” given above. The particle size distributions of AM metal compounds in the suspension utilized herein were measured using a HORIBA LA-960 laser scattering machine. Prior to sizing, the LA-960 is programmed with the refractive indices (RI) of water and the particle martials. The RI values for water, CuI, AgI and ZnO were 1.333, 2.35, 2.22, and 2.03, respectively. The table provides information regarding the suspensions used in the various examples of this disclosure.

TABLE 2
CuI Suspensions Size Data

| | % Solid | | | | |
|---|---|---|---|---|---|
| Suspension | Content | Mean Particle | Standard | % Over | % Under |
| ID | (% w/w) | Size (um) | Deviation (um) | 1 um | 100 nm |
| CuI-sus-01 | 15% | 0.07 | 0.015 | 0.00% | 95.80% |
| CuI-sus-02 | 10% | 0.08 | 0.112 | 0.62% | 94.69% |
| CuI-sus-03 | 18% | 0.56 | 0.464 | 8.11% | 1.04% |
| CuI-sus-04 | 23% | 1.29 | 1.280 | 44.30% | 0.51% |
| CuI-sus-05 | 15% | 0.61 | 0.515 | 9.87% | 0.82% |
| CuI-sus-06 | 15.8% | 0.58 | 0.614 | 13.57% | 3.43% |
| CuI-sus-07 | 22% | 1.9 (Bimodal, peaks | 1.8 | 59% | 0 |
| | | at 0.26 and 2.6, | | | |
| | | relative height* 1.2 | | | |
| CuI-sus-08 | 20% | 0.086 | 0.027 | 0 | 74% |
| CuI-sus-08(S) | 100% | 1.35 (Bimodal, peaks | 1.45 | 46% | 2% |
| | | at 0.23 and 1.73, | | | |
| | | relative height* 1.2 | | | |
| AgI-Sus-09 | 1.95% | 0.14 | 0.041 | 0% | 15.78% |

*Relative height (quantity) of the first to the second peak

CuI-sus-08 and CuI-Sus-08(S), are the same suspensions, other than that CuI-Sus-08 was dried in a rotary evaporator and stored as a dry powder CuI-Sus-08(S). This was resuspended in water by simply adding to water and stirring. Simple stirring may not be enough to reconstitute the original particle size distribution. This may require dispersion under high shear conditions, use of ultrasonic dispersion and or a quick grinding on a wet-mill I available. An advantage of using the dried material is that it may be transported more easily and reconstituted, or the dry powder may also be added to coating formulations that are non-aqueous or have compositions where solvent composition of the formulation may be altered by adding the aqueous suspension.

The solids content of suspensions was determined through simple gravimetric analysis. A small volume of the aqueous suspension containing the particles was weighed into a crucible then heated in an oven at 85° C. The crucible was periodically weighed until an equilibrium was reached and the final weight was recorded. The table above lists the solids content of some of these suspensions.

### Example 2: Antimicrobial Activity of CuI Suspensions: Impact of Particle Size and Suspension Storage Time

Antimicrobial efficacy of the various suspensions was tested against Pseudomonas aeruginosa (ATCC 27313, American Type Culture Collection (ATCC, Manassas, Va.). The samples were tested in triplicate, and the starting titer concentration was 2.03E+07 cfu/ml. CuI suspension CuI-Sus-07 was made and stored for four years and then evaluated against the other two which were used within a few months of their production. The Log₁₀ reduction values and standard deviation (SD) are reported. Copper concentration (present as CuI surface functionalized particles) in the microbial solutions is shown. The contact time between the antimicrobial suspension in the microbial solution is shown, prior to neutralizing the antimicrobial material. The symbol “>” indicates that the kill rate had reached the maximum and the remaining microbial population was below the detection limit. The results are in Table 3.

TABLE 3

| | Suspension type and average particle size | | | |
|---|---|---|---|---|
| | CuI-Sus-07 | CuI-Sus-02 | CuI-Sus-06 | |
| | 1.9 μm | 0.08 μm | 0.58 μm | Control |
| | Copper Conc, ppm | | | |
| | 60 | 41 | 60 | 0 |
| Time, Minutes | Log₁₀ Reduction ± SD | | | |
| 5 | 2.50 ± 0.06 | 3.16 ± 0.69 | 2.48 ± 0.09 | 0.09 ± 0.04 |
| 15 | >5.45 ± 0.28 | >5.61 ± 0.00 | >5.61 ± 0.00 | 0.13 ± 0.03 |
| 60 | >5.61 ± 0.00 | >5.61 ± 0.00 | >5.61 ± 0.00 | 0.35 ± 0.12 |

The results show that the antimicrobial efficacy of these materials is extremely large, and second their antimicrobial properties are highly stable over several years. The suspension prepared four years earlier (CuI-Sus-07) did not decrease in its antimicrobial efficacy. Further, even though there is a large difference in the particle size, within the temporal and the concentration parameters selected above we did not see significant differences in the antimicrobial efficacy. Mean particle size in microns is indicated below the suspension types.

### Example 3: Antimicrobial Activity of CuI Suspensions: Impact of Drying and Re-Constituting the Suspension

Various surface functionalized CuI particle suspensions were made in an aqueous medium as in Example 1 as listed below. One of these suspensions was dried into powder in a rotary evaporator. These were stored as a liquid and as solid dry powder respectively for about five years. The solid sample was reconstituted as a liquid suspension by adding water and mechanically stirring. Testing was done against Pseudomonas aeruginosa (ATCC 27313). The initial titer concentration of the microbe was 2.76E+07. The Log₁₀ reduction values and standard deviation (SD) are reported in Table 4. Copper concentration (present as CuI) in the microbial solutions 60 ppm. The contact time between the antimicrobial suspension in the microbial solution are shown prior to neutralizing the antimicrobial material.

TABLE 4

Suspension type and average particle size

| | | |
|---|---|---|
| | CuI-Sus-02 | |
| | 0.08 μm | |
| CuI-Sus-07 | (constituted | |
| 1.9 μm | from solids) | Control |

Copper Conc, ppm

| | | |
|---|---|---|
| 60 | 60 | 0 |

| | |
|---|---|
| Time, Minutes | Log₁₀ Reduction ± SD |

| | | | |
|---|---|---|---|
| 5 | 4.37 ± 0.21 | 3.16 ± 0.69 | 0.09 ± 0.01 |
| 15 | 5.64 ± 0.17 | >5.34 ± 0.46 | 0.06 ± 0.09 |
| 60 | >5.74 ± 0.00 | >5.74 ± 0.00 | 0.10 ± 0.04 |

The results show that within the parameters selected above reconstituting the surface functionalized particles from liquid suspension to solid and again to liquid suspension did not change its antimicrobial efficacy.

### Example 4: Results of Wetting Testing on Nonwoven Polypropylene Fabrics

In an initial test the polypropylene fabric was tested for its hydrophobicity by dropping 50 μl of water and also CuI (CuI-Sus-04) on a lightly stretched fabric and also solid polypropylene sheet. Both of these beaded up and maintained the bead-like geometry for several minutes after which the experiment was terminated. No visible spreading of these was seen. This shows that this fabric and the sheet used were hydrophobic. A coating formulation without surfactants was made by taking 19.673 g deionized (DI) water in a vial. To this, water soluble VA-64 copolymer was added in quantities of 0.025 g and subjected to magnetic stirring and sonication at room temperature. After the VA-64 was fully dissolved, 0.250 g of CuI-sus-04 was added and the sample was gently shaken. Next, 0.12 g of Advabond® 7200 was added followed by 1.14 g of ethanol. This formulation formed a bead and did not spread, and the experiment was terminated in a few minutes. It is to be noted that the binder Advabond® 7200 by itself did wet spread on the same fabric. In the concentration used in the formulation, it did not sufficiently lower the surface tension to wet the fabric. In order to be able to wet these fabrics effectively various surfactants (0.0456 g) were added to these formulations as shown in Table 5.

As noted in Table 5, all of the surfactants used wetted the fabric with the exception of Dynol™ 360, which did not wet the surface similar to the formulation without any surfactant. The wetting of the 50 μl drop roughly spread irregularly in an area of about 2 cm×2.5 cm. In Table 5 below, wetting times are noted in seconds. Faster times demonstrate superior wetting. Also, both Triton™ X100 and Dynol™ 360 are non-ionic organic surfactants. Surfynol® 2502 and Dynol™ 800 are both Gemini class surfactants and Tegopren® 5840 is a silicone-based surfactant. Further, Dynol™ 800 and Surfynol® 2502 wet the fabrics quickly than any other surfactants.

TABLE 5
Impact of various surfactants on the wetting behavior of PP fabric

| Sample ID | Surfactant | Time/s |
|---|---|---|
| A | Triton ™ X100 | 5 |
| B | Dynol ™ 800 | 3.40 |
| C | Dynol ™ 360 | Non-wetting |
| D | Surfynol ® 2502 | 4.20 |
| F | Tegopren ® 5840 | 4.88 |

Based on these results it was decided to try certain mixtures of surfactants. Some of these mixtures contain one Gemini class surfactant and some have only mixtures of different Gemini surfactants and tested for wetting the polypropylene fabric as shown in Table 6. This test is very important from an industrial perspective. If a non-wetting formulation is used, that means that the fabric will have trouble in being coated on industrial scale. As the coating solutions must wet the fabrics rapidly which are only contacting for a short duration in the process. As discussed in an earlier section, the spreading time period should be less than 10 s in one embodiment and less than 30 s in another embodiment. Dynol™ 360 did not wet the fabric for more than a few minutes.

Several formulations were made as above with Advabond® 7200 but with mixed surfactants Formulations 1a, 1d, 7a and 7c are quite similar. The differences between them as described below are absence or presence of ethanol or use of different CuI suspensions. The exact details of these formulations are provided in the examples below that provide details of various formulations. Specifically, Formulation 1a has ethanol, whereas the other three do not have ethanol. The CuI suspensions used in 1a and 1d are the same (CuI-Sus-04) and two different suspensions are used in 7a and 7c (CuI-Sus-05 and CuI-Sus-03 respectively).

TABLE 6
Wetting behavior of PP fabric by formulations
containing more than one surfactant

| Formulations | Surfactant | Time/s |
|---|---|---|
| 1a | Dynol ™ 800 + Triton ™ X100 | ~4 |
| 1d | Dynol ™ 800 + Triton ™ X100 | ~3 |
| 7a | Dynol ™ 800 + Surfynol ® 2502 | ~2 |
| 7c | Dynol ™ 800 + Surfynol ® 2502 | ~2 |

It appears from the above results that materially there is not much difference between these, and it may be that the presence of ethanol slightly degrades the wetting behavior when these two surfactants are present.

Formulations 3b, 3d, 5c, 5d, 7b and 7d contain crosslinkable binder along with Advabond® 7200. The wetting results on these are in Table 7. The composition of the crosslinkable binders is different for 5c and 5d. Formulation 3b and 5c have ethanol, whereas the other four do not have ethanol. The CuI suspensions used in 3b and 3d are the same (CuI-Sus-04) and two different suspensions are used in 7b and 7d (CuI-Sus-05 and CuI-Sus-03 respectively). In Formulations 5c and 5gone of the crosslinker is of low water solubility

TABLE 7
Wetting behavior of PP fabric by formulations
containing more than one surfactant

| Formulations | Surfactant | Time/s |
|---|---|---|
| 3b | Dynol ™ 800 + Triton ™ X100 | ~5 |
| 3d | Dynol ™ 800 + Triton ™ X100 | ~5 |
| 5c | Dynol ™ 800 + Triton ™ X100 | ~6 |
| 5g | Dynol ™ 800 + Triton ™ X100 | ~7 |
| 7b | Dynol ™ 800 + Surfynol ® 2502 | ~9 |
| 7d | Dynol ™ 800 + Surfynol ® 2502 | ~5 |

The above results show that these results are materially similar within the table, but are different from those in Table 6, where no crosslinkable binders were used. It is important to understand that it is not sufficient to only have an aqueous solution to be applied to a hydrophobic surface, but it also must wet the surface properly. Wetting is easier to see and characterize on solid surfaces by contact angle (where a contact angle of 90 degrees or greater is generally considered non wetting). However, this is difficult to define for porous substrates and fabrics, therefore the above-defined wetting criteria is very important. An aqueous formulation for coating must also wet the fabric properly, or the coating will be chunky and non-uniform which is not useful. Further, all surfactants will not result in a wetting formulation as seen above, and some surfactants will be better for some substrates while others may be more suitable for others. This is something which is not obvious, and comes with significant experimentation, and sometimes it is also surprising to see which materials work. The coatings need to be well adhered and uniform to get a high performance and also be safe, so that during use the particles and coatings are not easily removed and inhaled by the user of such products.

### Example 5 (Formulations 1a Through 1h): Preparation of Coating Formulation Using Water-Insoluble Binder

19.673 g deionized (DI) water was added to a vial. To this, water soluble VA-64 copolymer was added in quantities of either (1a) 0.025 g, (1b) 0.076 g, or (1c) 0.23 g and subjected to magnetic stirring and sonication at room temperature. After the VA-64 was fully dissolved, 0.250 g of CuI-sus-04 was added to each one of them and the samples were gently shaken. Next, to the above three solutions, Advabond® 7200 (a polymeric emulsion of a chlorinated thermoplastic polymer having maleic anhydride and polyolefin, in this case used as a binder and to promote adhesion to polyolefins) was added in quantities of (1a) 0.12 g, (1b) 0.23 g, and (1c) 1.13 g, respectively. To these three formulations, 0.0228 g each of Dynol™ 800 and Triton® X-100 were added, where Dynol™ 800 is a Gemini class surfactant and Triton™ X-100 is a non-ionic surfactant. To the above three compositions 1.14 g of ethanol was added as a co-solvent and was stirred magnetically which resulted in formulations 1a to 1c. Formulations (1d), (1e), and (1f) correspond to formulations prepared according to examples (1a), (1b), and (1c), respectively, without the addition of ethanol as a co-solvent. In addition, formulations 1g and 1h were similar to 1a and 1d, but did not contain any Advabond® 7200.

Several Advabond® formulations are available, which are 7424, 7419, 7251, 7498 and 7200. These were tested by wetting the polypropylene fabric by using them as received. Advabond® 7200 showed lower viscosity and the fastest wetting behavior and Advabond® 7498 beaded. Therefore, Advabond® 7200 was selected for adding to the formulations unless mentioned otherwise.

These formulations wetted the PP fabrics well as discussed in Example 4. The formulations were coated on PP fabric using the method described in paragraph [0068] above (“Method of coating nonwoven polypropylene fabric”). The coated fabrics were first air dried followed by transferring into the pre-heated oven at 85° C. for 30 minutes.

Coatings (after drying) resulting from formulations “1a” and “1d”, the water-soluble polymer volume fraction was 43% (both as added VA64 and also that was present in the suspension as the surface functionalization agent), the water insoluble binder as Advabond® 7200 volume fraction was 45% and the volume fraction of CuI was 12%. It can be seen that the volume fraction of the water-soluble polymer+the CuI particles was 55%, and that of the water insoluble binder was 45% (greater than 25%). To calculate these numbers, the dry densities of VA64, Advabond® 7200 and CuI were taken as 1.1, 1.1 and 5.67 g/cm3 respectively.

Similarly, the solid coating obtained from formulation “1b” and “1e” had volume fractions of water-soluble polymer as 52%, water insoluble binder as 42% and the CuI as 6%. These numbers for formulations “1c” and “1f” were 41%, 57% and 2% respectively. In all cases the volume fraction of the water-soluble polymer+the CuI particles was greater than 25%.

### Example 6 (Formulations 2a and 2b): Preparation of Coating Formulation Using Both Water-Insoluble and Water-Soluble Crosslinkable Acrylates and Triblock Copolymers as Compatibilizing Agent

To prepare formulation 2a, 19.673 g DI water was added to a vial. To this 0.400 g of water-soluble VA-64 copolymer was added and subjected to magnetic stirring and sonication at room temperature. After the VA-64 copolymer was fully dissolved, 0.460 g of CuI-sus-01 was added and the sample was gently shaken. Next 0.9393 g each of both SR-610 (water-soluble polyethylene glycol diacrylate monomer) and SR-644 (polypropylene glycol diacrylate monomer) were added and the sample shaken again. This was followed by the addition of 0.54 g of Pluronic® L-31, then 0.2450 g of Advabond® 7200, and 0.0245 g each of both Triton™ X-100 and Dynol™ 800 surfactants. In this case the crosslinkable acrylates and the Advabond® serve as a binder, and the Pluronic serves as a compatibilizing agent for the two crosslinkable acrylates. To all of them, 1.14 g of ethanol was added, and the formulation was stirred magnetically, followed by the addition of 0.009393 g of a Vazo™ 56 WSP water soluble polymerization initiator and stirring to complete. Since in this and the other examples the quantity of the initiator was small it was added by preparing a dilute solution of the initiator in water and then pipetting 50 to 200 μl of this solution. Formulation 2b corresponds to formulation prepared according to the Formulation 2a, excluding the addition of ethanol as a co-solvent.

These formulations wetted the PP fabrics as well as those discussed in Example 4. The formulations were coated on PP fabric using the Method 1a described earlier in paragraph [0068]. the coated fabrics were dried and cured at 85° C. for 120 minutes.

Coatings on these fabrics after curing contain by volume, 86.9% binder (including the acrylates and the Advabond®), 12.2% water-soluble polymer (including additional VA64), and 2.7% AM solids (which contains surface functionalized CuI particles from the aqueous suspension). The percentage of AM solids includes both the AM metal compound and functionalizing agent. As in Example 5, the volume of the binder is larger than the combined volume of the solids contributed by other components of the formulation.

### Example 7 (Formulations 3a 3b): Preparation of Coating Formulation Using Binders Having Both Crosslinkable Acrylates and Emulsion of Water Insoluble Polymer

In this example formulation 3a was made by taking 19.673 g DI water in a vial. To this 1.151 g of water-soluble VA-64 copolymer was added and subjected to magnetic stirring and sonication at room temperature. After the VA-64 copolymer was fully dissolved, 0.310 g of CuI-sus-01 was added and the sample was gently shaken. Next, 0.1658 g each of both poly (ethylene glycol) diacrylate (PEGDA, Mₙ=575) and SR-611 (alkoxylated tetrahydrofurfuryl acrylate) monomers were added, followed by 0.228 g of Advabond® 7200, then 0.0228 g each of both Dynol™ 800 and Triton™ X-100 surfactants. In this case both the crosslinkable acrylates and the Advabond® serve as a binder. Finally, 1.14 g of ethanol was added, and the formulations stirred magnetically, followed by 0.001658 g of a Vazo™ 56 WSP thermal polymerization initiator and stirring. Formulation 3b corresponds to formulations prepared according to formulation 3a, excluding the addition of ethanol as a co-solvent. These formulations wetted the PP fabrics as well as those discussed in Example 4. The PP fabric was coated using these formulations and dried and cured at 85° C. for 120 minutes.

### Example 8 (Formulations 4a to 4d): Preparation of a Coating Formulation Using Binders Containing (1) PEG-Based Acrylates and (2) with and without Water Insoluble Polymer Added as an Emulsion

Formulation 4a: 19.673 g DI water was added to a vial. To this, 1.151 g of water-soluble VA-64 copolymer was added and subjected to magnetic stirring and sonication at room temperature. After the VA-64 copolymer was fully dissolved, 0.370 g of CuI-sus-01 was added and the sample was gently shaken. Next, 0.3312 g of poly (ethylene glycol) diacrylate (Mₙ=575) was added, followed by 0.0226 g of Advabond® 7200, then 0.0226 g each of both Dynol™ 800 and Triton™ X-100 surfactants. In this case, the crosslinkable acrylate and Advabond® 7200 serve as binders, and the Advabond® also promotes adhesion with polyolefins. Finally, 1.14 g of ethanol was added, and the formulation was stirred magnetically, followed by 0.001660 g of a Vazo™ 56 WSP thermal polymerization initiator and stirring to complete the formulation.

Formulation 4b: 7.869 g DI water was added to a vial. To this, 1.151 g of VA-64 copolymer was added and subjected to magnetic stirring and sonication at room temperature. After the VA-64 copolymer was fully dissolved, 0.135 g of CuI-sus-01 was added and the sample was gently shaken. Next, 0.3294 g of poly (ethylene glycol) diacrylate (Mₙ=575) was added, followed by 0.0118 g each of both Dynol™ 800 and Triton™ X-100 surfactants. In this case, the crosslinkable acrylate serves as a binder. Finally, 0.789 of ethanol was added and the formulation was stirred magnetically, followed by 0.00165 g of Vazo™ 56 WSP and stirring to complete.

Formulations 4c and 4d are the formulations prepared according to formulations 4a and 4b respectively, excluding the addition of ethanol.

These formulations wetted the PP fabrics well as discussed in Example 11. PP fabric was coated using these formulations. The coating method and drying of the fabric was as in Example 7.

### Example 9 (Formulation 5a to 5h): Preparation of Coating Formulation Using Binders Containing (1) Blended Acrylate Monomers and (2) Water Insoluble Polymer Added as an Emulsion

Formulation 5a: 20 g DI water was added to a vial. To this vial, 0.8 g of water-soluble VA-64 copolymer was added and subjected to magnetic stirring and sonication at room temperature. After the VA-64 copolymer was fully dissolved, 0.310 g of CuI-sus-01 was added and the sample was gently shaken. Next, 0.3587 g each of both SR9035 (ethoxylated trimethylolpropane acrylate) and SR611 (alkoxylated tetrahydrofurfuryl acrylate) monomers were added, followed by 0.230 g of Advabond® 7200, then 0.023 g each of both Dynol™ 800 and Triton™ X-100 surfactants. Finally, 1.16 g of ethanol is added, and the formulation was stirred magnetically, followed by 0.003587 g of a Vazo™ 56 WSP thermal polymerization initiator and stirring to complete.

Formulation 5b: 19.673 g DI water was added to a vial. To this, 1.151 g of VA-64 copolymer was added and subjected to magnetic stirring and sonication at room temperature. After the VA-64 copolymer was fully dissolved, 0.270 g of CuI-sus-01 was added and the sample was gently shaken. Next, 0.1654 g each of both SR644 (polypropylene glycol acrylate) and SR610 (polyethylene glycol diacrylate) monomers were added, followed by 0.228 g of Advabond® 7200, then 0.0228 g each of both Dynol™ 800 and Triton™ X-100 surfactants. Finally, 1.140 g of ethanol was added, and the formulation was stirred magnetically, followed by 0.001654 g of Vazo™ 56 WSP and final stirring.

Formulation 5c: 19.673 g of DI water was added to a vial. Next, 0.309 g of CuI-sus-01 was added and the sample was shaken to disperse. To this, 0.72 g each of both SR644 and SR610 were added, followed by 0.228 g of Advabond® 7200, then 0.0228 g each of both Dynol™ 800 and Triton™ X-100 surfactants. Finally, 1.140 g of ethanol was added, and the formulation was stirred magnetically, followed by 0.0072 g of Vazo™ 56 WSP and final stirring.

Formulation 5d: 9.80 g of DI water was added to a vial, followed by 1.151 g of VA-64 copolymer. After using magnetic stirring and sonication to dissolve the VA-64, 0.30 g of CuI-sus-01 was added and the sample was shaken to disperse. To this, 0.516 g each of both SR644 and SR610 were added, followed by 0.236 g of Advabond® 7200, then 0.0228 g each of both Dynol™ 800 and Triton™ X-100 surfactants. Finally, 0.620 g of ethanol was added, and the formulation is further stirred, followed by the addition of 0.00519 g of Vazo™ 56 WSP and more stirring.

Formulations e through h were prepared according to the formulations a to d respectively, excluding the addition of ethanol as a co-solvent. In all of these sub-examples, both the crosslinkable acrylate monomers and Advabond® 7200 emulsion serve as a binder.

These formulations wetted the PP fabrics as well as those discussed in Example 4. For coating and drying of PP fabric using these formulations, the procedure described in Example 7 was used.

### Example 10 (Formulations 6a to 6b): Preparation of a Coating Formulation Using Acrylic Binders

Formulation 6a: This was similar to Formulation 1a, excepting that 0.025 g VA64 copolymer was replaced by 0.40 g an acrylic emulsion RayCryl 918k. The CuI suspension used was CuI-Sus-04.

Formulation 6b: This was similar in the use of ingredients as Formulation 6a, except that no Advabond® was used. 10 g deionized (DI) water was added to a vial. To this, 1 g of Raycryl 918K was added followed by 0.025 g of suspension CuI-Sus-04. To this was added 0.113 g each of Triton™ X100 and Dynol™ 800.

These formulations wetted the non-woven PP fabrics as well as those discussed in Example 4. These formulations were coated on the non-woven PP fabric using the Method 1a (in paragraph [0068]). The coated fabrics were first air dried followed by transferring into the pre-heated oven at 85° C. for 30 minutes.

### Example 11 (Formulations 7a to 7d): Preparation of Coating Formulations Containing More than One Type of Gemini Surfactant

Formulations 7a and 7c: These formulations were identical, other than different types of CuI suspensions were used. Formulation 7a used 0.4 g CuI-Sus-05 and Formulation 7c used 0.3 g of CuI-Sus-03. To prepare these 19.6 g deionized (DI) water was added to a vial. To this, water soluble VA-64 copolymer was added in a quantity of 0.025 g and subjected to magnetic stirring and sonication at room temperature. After the VA-64 was fully dissolved, the CuI suspension was added, and the sample was gently shaken. Next, Advabond® 7200 was added in a quantity of 0.12 g, followed by the addition of 0.0228 g each of Dynol™ 800 and Surfynol® 2502.

These formulations wetted the PP fabrics as well as those discussed in Example 4. These formulations were coated on PP fabric using Method 1a. The coated fabrics were first air dried followed by transferring into the pre-heated oven at 85° C. for 30 minutes.

Formulations 7b and 7d: These formulations were identical, other than different types of CuI suspensions were used. Formulation 7b used 0.4 g CuI-Sus-05 and Formulation 7d used 0.35 g of CuI-Sus-03. These were made by taking 19.6 g DI water in a vial. To this 1.151 g of water-soluble VA-64 copolymer was added and subjected to magnetic stirring and sonication at room temperature. After the VA-64 copolymer was fully dissolved, CuI suspension was added and the sample was gently shaken. Next, 0.1658 g each of both poly (ethylene glycol) diacrylate (PEGDA, Mₙ=575) and SR-611 (alkoxylated tetrahydrofurfuryl acrylate) monomers were added, followed by 0.228 g of Advabond® 7200, then 0.0228 g each of both Dynol™ 800 and Surfynol® 2502 surfactants. In this case both the crosslinkable acrylates and the Advabond® serve as a binder. The formulations stirred magnetically, followed by 0.001658 g of a Vazo™ 56 WSP thermal polymerization initiator and stirring to complete.

These formulations were coated on the PP fabric and dried as above

### Example 12: Adhesion Results of Coating on Polypropylene Sheets

Table 8 below lists selected adhesion testing results of coatings on an extruded solid polypropylene sheet. Each coating is given a rating between 0B and 5B according to ASTM D3359. A rating of 0B represents poor to no adhesion accompanied by coating failure, and a rating of 5B represents good adhesion and no visible peeling.

TABLE 8
Adhesion ratings of the selected formulation.

| Formulation ID | Adhesion |
|---|---|
| 1a (with ethanol) | 5B |
| 1d (w/o ethanol) | 5B |
| 1b (with ethanol) | 5B |
| 1d (w/o ethanol) | 5B |
| 1c (with ethanol) | 5B |
| 1f (w/o ethanol) | 5B |
| 1g Without Advabond ® (with ethanol) | 1B |
| 1h (w/o Advabond ® and ethanol) | 1B |
| 3a (with ethanol) | 3B |
| 3b (w/o ethanol) | 3B |
| 4b (F23) | 1B |

The formulations 1g, 1h and 4b did not contain any Advabond®, which shows that the presence of Advabond® was useful in obtaining good adhesion. The presence/absence of ethanol in the formulation does not seem to impact the adhesion value, for example formulations 1a, 1b, 1c, 1g and 3a were with ethanol, and the corresponding formulations 1d, 1f, 1h and 3b were without ethanol.

### Example 13: Evaluation of Coating Weight and Copper Extraction Results of Coated Nonwoven Polypropylene Fabrics

Table 9, lists select results of some of the coatings on weight gain (and GSM) and the amount of copper extracted in aqueous and oil media. The weight gain of the fabrics after coating (and drying) is reported in two ways, as % increase based over the uncoated fabric and as GSM which is the coating weight in g/sq-m of the fabric area. The starting weight of the uncoated fabric was 25 g/m² (or 25 GSM). The % Cu extracted is based on the total amount of copper present in the coated fabric. The numbers reported here are the average of duplicate runs performed within the saline and oil medium.

TABLE 9
Extraction and Weight Gain Data of Selected
Coating Formulations, in Saline Solution

| | % solids | | | | | |
|---|---|---|---|---|---|---|
| | in the | | | | % Cu | |
| | coating | % | | % Cu in | Extracted | % Cu |
| Formu- | formu- | Weight | Coating | Solid | in saline | Extracted |
| lation | lation | Gain | GSM | Coating | medium | in oil |
| 1a | 0.77 | 4.3% | 0.96 | 9.64% | 5.6% | 12.4% |
| 3a | | 14.5% | 3.78 | 1.01% | 41.6% | Not |
| | | | | | | evaluated |
| 3b | 7.32 | | | | | |
| 4a | | 11.4% | 2.79 | 0.99% | 57.4% | 20.7% |
| 5a | \grave{ } | 27.6% | 6.48 | 1.03% | 22.5% | Not |
| | | | | | | evaluated |
| Ex 4b | 14.9 | 25.4% | 6.66 | 0.46% | 41.1% | 12.5% |

The amount of weight gained is strongly correlated to the solids content in the formulation. The total amount of copper extracted in water from the coatings produced from formulation 1a and 3a are similar although they have very different copper contents and the % of copper extracted from the coating. The main difference is the use of a high concentration of water-soluble polymer in formulation 3a relative to the formulation 1a. Since the antimicrobial properties of coatings are dependent on the amount of copper ions released, both coatings are expected to perform equivalently in antimicrobial tests. This was seen for coatings 1a and 4a when applied to the non-woven PP fabric and discussed in Example 13. However, the durability of the coatings from 1a are expected to be superior, particularly in repeated testing of the same spot. Thus, by varying the parameters such as water-soluble polymer (thermoplastic or crosslinked) and the water insoluble binder, both the copper extraction in water and in oil can be varied to a significant extent. In a multi-layer mask, when only one layer is coated, the amount of the antimicrobial agent in a mask is substantially lower as compared to the above values.

### Example 14: Antimicrobial Activity Results of Select Coatings on Polypropylene Fabrics

Coated, nonwoven polypropylene fabrics were evaluated using a slightly modified version of the standard procedure ISO 18184 against the microbe MS-2 Coliphage. Tests were split over several days, and the mean concentrations recovered from both control fabrics at time zero were 4.3×10⁷ and 5.9×10⁷ plaque-forming unit (PFU). These mean concentrations were used to calculate the Log₁₀ kill against MS-2 coliphage on the control and coated fabrics at different contact times. The results of the table below are associated with formulations prepared according to Formulation 1a and Formulation 4b, though the CuI suspensions used were different: the coating formulations 4b-1 and 1a-1 samples were prepared using suspension CuI-Sus-04, and the 1a-2 sample was prepared using suspension CuI-Sus-01. The controls were uncoated fabrics. Since the tests on fabrics coated with 4b were done at a different time as compared to 1a, there are two controls. The results are in Table 10.

TABLE 10
Antimicrobial Activity Results of Select
Coatings against MS-2 Coliphage

| | | | 4b | 1a | | | |
|---|---|---|---|---|---|---|---|
| Time | | Replicate | Control | Control | 4b-1 | 1a-1 | 1a-2 |
| 1 | min | A | *NP | *NP | 5.76 | 5.37 | 4.58 |
| | | B | | | 5.76 | 5.37 | 5.17 |
| 5 | min | A | *NP | *NP | 5.45 | 5.30 | 5.03 |
| | | B | | | >5.76 | 5.30 | >6.07 |
| 15 | min | A | *NP | 0.05 | 5.16 | 5.93 | 4.55 |
| | | B | | 0.00 | 5.86 | 4.89 | 5.93 |
| 30 | min | A | *NP | 0.07 | 5.02 | >5.93 | 5.93 |
| | | B | | 0.13 | 5.02 | >5.93 | >5.93 |
| 2 | hours | A | *NP | 0.04 | 5.86 | 5.63 | 4.59 |
| | | B | | 0.00 | 5.16 | 5.93 | 5.03 |
| 6 | hours | A | 0.76 | 0.53 | >5.86 | 5.63 | >5.93 |
| | | B | 0.09 | 0.41 | >5.86 | >5.93 | >5.93 |
| 24 | hours | A | 0.86 | 1.13 | >5.86 | >5.93 | >5.93 |
| | | B | 2.02 | 1.52 | >5.86 | >5.93 | 5.45 |

Note:
Control fabrics were uncoated. Sample identifiers “1a-1” and “1a-2” would refer to two replicates prepared according to coated fabrics using Formulation 1a and 4b-1 is prepared using formulation 4b.
*NP = Not Performed.

The above table shows the outstanding antimicrobial effectiveness imparted to the fabrics by the coatings containing the antimicrobial suspension. All of the tested coatings exhibited >99.99% reduction in the bacterial population within the shortest time of only one minute. The choice of water-insoluble binder or water-soluble binder had little effect on the relative antimicrobial effectiveness of the coating. Example 13 provided details on the copper content of these coatings, and on the amount of water extraction. As noted above, the controls (non-coated samples) were only tested at six and twenty-four hours and these did not show significant antimicrobial activity as compared to the coated samples. At twenty-four hours on the control samples there was a relatively higher reduction of the virus due to its natural death. Also, it should be noted that while the suspensions CuI-Sus-04 and CuI-Sus-01 had a very different particle size distribution (Example 1), their antimicrobial performance within this range of particles was quite similar. This would imply that particles within this range would also have similar antimicrobial performance.

In another test, where the coating integrity and its performance was checked by using a challenge test. Coating 1a was tested repeatedly at the same spot for antimicrobial efficacy to mimic what would happen to a user who wore a fabric, for example, a mask, made out of this material for a long time. Using MS2 as the microbe and the contact time being 5 minutes, four sets of samples (two each) of coated polypropylene fabrics were taken. All four were spotted with the same viral (aqueous) solutions (with appropriate control blanks) and using standard methodology. After 5 minutes the first set was analyzed for residual active-microbe. One hour later the remaining three were spotted with the viral solution in the same place, and after 5 minutes one set of fabric was analyzed for residual active-microbe to see if the initial spotting had removed or decreased the efficacy of the fabric. This was repeated with the other two after three and eight hours. As compared to a blank, the log-kill rates that were obtained relative to the uncoated fabric were 5.26, 5.82, 5.01 and 4.73 (respectively at time, t=0, after one hour, after 3 hours and after eight hours). This shows that the quality of the coatings was superb and the antimicrobial agent did not dissolve or was removed due to repeated challenges in that area. This excellent behavior would difficult to replicate for coatings which have water soluble binders and are readily removed from the surface.

### Example 15: Effect of Formulation Dilution on Wettability, Coating GSM and Antimicrobial Properties on Coated Non-Woven PP Fabric

This experiment was carried out using formulation 1a (Example 5) but further diluting this formulation using DI water by a factor of 2, 5 and 10 times. The impact of dilution on coatability, wettability, GSM and antimicrobial properties (using MS2) was determined.

20 g of deionized (DI) water was added to four different vials. To each of these, 0.025 g of water-soluble VA-64 copolymer was added and subjected to magnetic stirring and sonication at room temperature. After the VA-64 was fully dissolved, 0.32 g of CuI-sus-03 was added to each of these vials and the samples were gently shaken. Next, to each of the above three solutions 0.12 g of Advabond® 7200 was added. To these formulations, 0.0228 g each of Dynol™ 800 and Triton™ X-100 were added. one of these four was kept aside to form the undiluted formulation and the others were diluted by adding 180 ml, 80 ml and 20 ml of water to form formulations 10-, 5-, 2-times (×) dilution, respectively. When the dilution was 2×, the wettability was no different as compared to the non-diluted sample (see Example 12). The wettability suffered considerably at 5 and 10× dilutions, where it was noticed that for 5× dilution the wetting time increased to about 35 s and at 10× it was about 2 minutes with also smaller wetting spreads. However, even under these conditions, the fabrics could be coated as discussed below; thus surfactant amounts were not adjusted, otherwise their amount in the coatings would have been much higher as compared to copper (from copper iodide). A fifth undiluted formulation was also made which did not have any CuI suspension, all the other ingredients were the same, and this was used to coat the control fabric.

These formulations were coated on the fabric using the laboratory wringer (model XHF-54, China). Constant pressure was applied by applying 546 g weight. For all GSMs, single pass was used at a linear speed of 25 mm/s. The coated fabrics were first air dried followed by transferring into the pre-heated oven at 85° C. for 30 minutes.

The weight gain in Gram per Square (GSM) of the dry coating obtained are shown in the table below. The Antimicrobial results using MS2 bacteriophage are shown in the Table 11. The average values of the log 10 reduction for three samples after one minute of contact time and their standard deviations are shown below.

TABLE 11
Antimicrobial results

| Degree of | | Log₁₀ reduction |
|---|---|---|
| Dilution | GSM | Average ± SD |
| Control Fabric | 0.65 | 0.08 ± 0.05 |
| Undiluted | 0.71 | 4.34 ± 0.33 |
| 2 X dilution | 0.37 | 3.47 ± 0.88 |
| 5 X dilution | 0.15 | 1.43 ± 0.65 |
| 10 X dilution | 0.05 | 0.47 ± 0.35 |

These results show that beyond 2× dilution there is a substantial drop in antimicrobial activity.

### Example 16: Air Flow Testing Results of Select Coatings

Airflow measurements were done to determine if the coatings had an adverse impact on the breathability by blocking the pores in the fabric, for this purpose uncoated fabric was compared with coated fabrics. As a comparison one of the coated fabrics used the same formulation as was used to prepare “undiluted coating” from Table 11 (Example 15) using CuI suspension CuI-Sus-03. This is called “standard coating”. Three other coatings were made with higher concentration of the ingredients in an amount of 2, 5, 10 time (×) of the “undiluted coating” amount.

These wet coated fabrics were squeezed using the laboratory wringer (Jinan Xinghua Instrument Ltd, model XHF-54, China). Constant pressure was applied by applying 546 g weight. For all GSMs, single pass was used at a linear speed of 25 mm/s. Please note that for earlier experiments a manual roller wringer was used. The coated fabrics were first air dried followed by transferring into the pre-heated oven at 85° C. for 30 minutes. Table 12 shows the GSM values for these coated fabrics. Please note that in this Table the GSM values are slightly higher as compared to those reported in Table 11. This may be due to more mechanized wringer that was used.

TABLE 12

| Samples | | # |
|---|---|---|
| detail | GSM | Sample |
| Uncoated | 0 | 3 |
| Standard | 1.06 | 1 |
| coating | | |
| 2X higher | 2.01 | 1 |
| Conc | | |
| 5X higher | 5.24 | 1 |
| Conc | | |
| 10X higher | 10.05 | 1 |
| Conc | | |

The purpose of using higher concentrations was to load the fabric with significantly higher amounts of material to understand if this significantly blocked air flow. In addition, airflow was measured through single layers of fabrics (coated and uncoated) and also through 3 layers of fabrics. For coated fabrics the measurement with three layers was done by positioning uncoated fabrics on either side of the coated fabric. This was done as in many applications, such as face masks multiple fabric layers are used to prevent the microbes from getting to the mask wearer. For example, in N95 masks (or equivalent), 95% of the particles above a size of 300 nm are blocked and may use 3 to 7 layers of fabrics depending on their characteristics. In these masks all layers may not be coated. For example, in some cases only one or more of the interior layers are coated, and in some cases the exterior layers may also be coated to kill the microbe as it lands on the mask. The layer touching the face of the wearer may not be coated to prevent antimicrobial material in coming with direct contact of the mask wearer. Thus, in the masks with multiple layers, at least one of the layers may be coated. The results of the pressure drop are shown in Table 13.

TABLE 13

| | Pressure drop (mm of water) | |
|---|---|---|
| Fabric | Average | Std Dev |
| Uncoated 1 | 1.78 | 0.503 |
| Uncoated 2 | 1.80 | 0.407 |
| Uncoated 3 | 1.59 | 0.186 |
| Uncoated 1 + Uncoated 2 + Uncoated 3 | 6.59 | 0.141 |
| Coated Std | 1.38 | 0.332 |
| coated 2X | 1.27 | 0.199 |
| coated 5X | 1.54 | 0.333 |
| coated 10X | 1.81 | 0.209 |
| Uncoated 1 + Coated Std + Uncoated 3 | 6.15 | 0.127 |
| Uncoated 1 + Coated 2X + Uncoated 3 | 6.37 | 0.179 |
| Uncoated 1 + Coated 5X + Uncoated 3 | 6.33 | 0.400 |
| Uncoated 1 + Coated 10X + Uncoated 3 | 6.50 | 0.189 |

The results show that the coated fabrics had very similar pressure drops as compared to the uncoated fabrics, which showed that it would not impact breathability. However, there was a substantial pressure increase when 3 layers of fabrics were used, whether coated or not coated.

### Example 17 Coating of Fabrics Used for Hospital Gowns

A coating formulation was made by mixing 10 g of a commercially available aliphatic polyurethane (aqueous) dispersion Bondthane™ UD315 and 0.8 g of CuI-Sus-04. Several commercial gowns were obtained which had different fabrics, these were woven using yarns made from polyester filaments (Fabric-1), stretchable fabric made by knitting using yarns made from polyester filaments (Fabric-2) and knitted fabric made of yarns produced by blending polyester and cotton fibers (Fabric 3). The formulations were coated on the fabrics by spraying. The amount of copper on the fabrics (present as CuI) was measured by complete dissolution of the fabrics in strong acids and measuring the copper content by ICP as discussed above. The copper content on the three fabrics respectively was 148±35, 355±74 and 377±47 mg/m², Three samples of each were analyzed. The numbers following “±” are standard deviations. The coating quality was improved by adding 1% of a surfactant Capstone FS-31.

The antimicrobial properties of these fabrics were measured using MS2 bacteriophage. Samples were inoculated with 200 μl of virus stock and recovered in 1 ml of D/E neutralizing broth. An average of 6.43×10⁶ PFU/ml was recovered from the duplicate control Fabric 1 samples, 5.03×10⁶ PFU/ml from the duplicate Fabric 3 control fabric samples, and 8.95×10⁶ PFU/ml from the duplicate Fabric 2 control fabric samples at time “Zero”. The symbol “>” means that the number of virus particles recovered was below the detection limit of the assay (5.0 PFU/ml).

The results of antimicrobial testing are shown in the Table 14 below, where the contact time between the fabric and the microbe was 60 minutes, prior to the neutralization. This experiment was done on replicates of two samples each. Control fabrics were not coated.

TABLE 14
Log₁₀ kill rates on fabrics.

| Replicate | Fabric 1 (control) | Fabric 1 (coated) |
|---|---|---|
| A | 1.30 | >5.98 |
| B | 1.37 | >5.98 |
| | Fabric 2 (control) | Fabric 2 (coated) |
| A | 1.25 | 4.34 |
| B | 1.08 | 4.18 |
| | Fabric 3 (control) | (Fabric 3 (coated) |
| A | 0.96 | >5.87 |
| B | 0.86 | >5.87 |

Some of the concentrations, amounts, and other numerical data are presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 0.01 to 2.0” should be interpreted to include not only the explicitly recited values of about 0.01 to about 2.0, but also include individual values and sub-ranges within the indicated range. Thus, included in this numerical range are individual values such as 0.5, 0.7, and 1.5, and sub-ranges such as from 0.5 to 1.7, 0.7 to 1.5, and from 1.0 to 1.5, etc. Furthermore, such an interpretation should apply regardless of the breadth of the range or the characteristics being described. Additionally, it is noted that all percentages are in weight, unless specified otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein. For example, in one aspect, the degree of flexibility can be within about ±10% of the numerical value. In another aspect, the degree of flexibility can be within about ±5% of the numerical value. In a further aspect, the degree of flexibility can be within about ±2%, ±1%, or ±0.05%, of the numerical value. Numerical quantities given are approximate, meaning that the term “around,” “about” or “approximately” can be inferred if not expressly stated.

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations is not intended to convey that the claimed subject matter requires features or combinations of features other than those expressly recited in the claims. Accordingly, the scope of this disclosure is intended to include all modifications and variations encompassed within the spirit and scope of the following appended claims.

1. A combination comprising a coating formulation and a hydrophobic fabric for providing antimicrobial properties to a fabric to which the coating formulation is applied, wherein the coating formulation
(a) wets the substrate,
(b) comprises an aqueous suspension containing at least 35% of one water insoluble polymer and at least one low water solubility antimicrobial material.

2. The combination of claim 1, wherein the coating formulation additionally contains at least one of another antimicrobial material, an antibiotic and an antiviral agent.

3. The combination of claim 2, wherein the fabric comprises a polypropylene polymer.

4. The combination of claim 2, wherein the fabric is a nonwoven fabric.

5. The combination of claim 1, wherein the low water solubility antimicrobial material comprises surface functionalized particles of cuprous iodide.

6. The combination of claim 5, wherein the combination has properties such that, when put in contact with MS2 coliphage, the combination kills at least 99.9% of said MS2 coliphage in a period of 15 minutes or less.

7. The combination of claim 1, wherein the low water solubility antimicrobial material in the coating is present in a concentration greater than 0.1% and less than 35% by weight of the coating.

8. A personal protective item selected from a face mask, a gown, and a hair covering comprising the combination of claim 2.

9. A personal protective item of claim 8 containing multiple layers of fabric, wherein at least one of the layers is provided with the coating formulation.

10. A product selected from at least one of a face mask, a hair covering or a gown comprising a polypropylene fabric provided with a coating of an antimicrobial formulation comprising particles of a low water solubility copper compound and at least one water insoluble polymer wherein the said formulation wets the polymer fabric.

11. The product of claim 10, wherein the low water solubility copper compound is comprises surface functionalized particles of CuI.

12. The combination of claim 1, wherein the coating formulation additionally at least one of another antimicrobial material, an antibiotic and an antiviral agent.

13. The product of claim 10, wherein the low water solubility copper compound in the coating is present in a concentration greater than 0.1% and less than 35% by weight of the coating.

14. The product of claim 10, containing multiple layers of fabric, at least one of which is provided with the coating.

15. The product of claim 10, wherein the coating is applied from an aqueous formulation.

16. The product of claim 11, wherein the product has properties such that, when put in contact with MS2 coliphage, the product kills at least 99.9% of said MS2 coliphage in a period of 15 minutes or less.

17. A mask or gown comprising a fabric of a hydrophobic polymer coated with an aqueous formulation of cuprous iodide particles which, when put in contact with MS2 coliphage, kills at least 99.9% of said MS2 coliphage in a period of 15 minutes or less.

18. The mask or gown of claim 17, wherein the hydrophobic polymer is polypropylene.

19. The mask or gown of claim 17, wherein the cuprous iodide particles are surface functionalized.

20. A mask or a gown comprising a non-woven hydrophobic polymer fabric with a coating comprising functionalized particles of cuprous iodide deposited from an aqueous suspension containing at least one surfactant and one polymer that is not water soluble, wherein the aqueous suspension wets the polymer fabric.
